(19) United States
(12) Patent Application Publication
(10) Pub. No.: US 2017/0226729 A1
(43) Pub. Date: Aug. 10, 2017

(54) SEDIMENT FILTRATION DEVICE, METHOD AND SYSTEM

(71) Applicants: Eric J. LOVE, North Sydney (AU); Christopher J. ROCHFORT, North Sydney (AU)

(72) Inventors: Eric J. LOVE, North Sydney (AU); Christopher J. ROCHFORT, North Sydney (AU)

(21) Appl. No.: 15/500,785

(22) PCT Filed: Jul. 31, 2015
(86) PCT No.: PCT/IB2015/001806

§ 371 Date: Jan. 31, 2017

Related U.S. Application Data
(60) Provisional application No. 62/031,404, filed on Jul. 31, 2014.

(51) Int. Cl. E03F 5/16; B01D 39/08; E03F 5/04; B01D 29/50; C02F 1/00; C02F 1/44; B01D 29/31; B01D 61/14

(52) U.S. Cl. CPC E03F 5/16; B01D 29/31; B01D 39/08; B01D 61/147; B01D 61/142; B01D 29/50; C02F 1/004; C02F 1/444; E03F 5/0404; C02F 2103/001

(57) ABSTRACT

A filtration system having a malleable compartment and a handle. The malleable compartment has a permeable fabric forming an exterior of the malleable compartment. The exterior at least partially faces a contaminated fluid. The permeable fabric has a pore size that defines the permeability of the fabric. The malleable compartment also has an interior that holds an interchangeable microfiltration medium. The microfiltration medium has a pore size that is smaller than the pore size of the permeable fabric. The filtration system also included a handle that is affixed to the malleable compartment.

### CROSS-REFERENCE TO RELATED APPLICATION

This application claims the benefit of U.S. Provisional Patent Application Ser. No. 62/031,404, filed on 2014 Jul. 31, by Love, et al., having the title “Sediment Filtration Device, Method and System,” which is incorporated by reference in its entirety as if expressly set forth herein.

### TECHNICAL FIELD

The present invention relates to sediment filtration devices, methods and systems, and in particular but not exclusively, to filter or reduce contaminants contained in contaminated fluid from entering waterways such as storm water drains.

### COPYRIGHT NOTICE

This document is subject to copyright. The reproduction, communication and distribution of this document is not permitted without prior consent from the copyright owner, other than as permitted under section 226 of the Patents Act 1990.

### BACKGROUND

### Flow Plus Filtration

Waterways need clear flow paths, so in cleansing contaminated water at filtration points or boundaries, both water flow and decontamination requires optimisation. There is a need to remove sediment and contaminants whilst maintaining water flow at a sufficient speed so as to limit any back-flooding and/or damming.

There are many devices that aim to provide filtration of water flow into water catchments such as storm water drains and/or waterway cleansing; however, many of these are not optimal since they require pre-installation and are not adaptable when conditions change such as exposure to new contaminants and/or unusual water flow volume and/or speed. Sediment filtration devices, methods and systems therefore need to provide sediment/contaminant-water exchange mechanisms as the need arises to assist water flow, sediment/contaminant capture and/or removal.

### Access and Sensitivity to Environment

Devices, systems and methods used to cleanse sediment from contaminated water that is flowing have included a variety of solutions including pumping devices and other mechanical apparatus. These devices are reliant on access to established operational infrastructure such haulage to the site, fuel, space, static conditions etc., whilst not necessarily being sensitive to the environment that they are to be operational within. Likewise, they are neither adaptable to dynamically be adjusted to meet immediate and/or changing environmental needs nor scalable to filter water as its volume/direction/velocity changes. Therefore, there needs to be a sediment filtration device that can be mobilised quickly into remote and relatively inaccessible locations and/or to be modified as new contamination conditions arise.

Likewise, passive exchange systems that do not require mechanical means to operate, to date, have had limited scalability and flexibility for meeting dramatic changes to water flow and to fluctuations in sediment/contamination profile required to be captured. For example, hay bales have been used to exclude sediments and thus perform a macro filtration; however, they do not provide any form of selective macro- and/or micro-filtration. They also biologically degrade rapidly, leaching dissolved organic carbons (DOC) and potentially seeds harmful to the ecosystem.

A community's water needs has historically been built and based on:
a. water consumption priorities;
b. interpretations of what clean water consists of, and/or
c. extrapolations of possible water decontamination and sediment filtration requirements.

Such interpretations of water need change as we become more aware of potentially harmful contaminants. Therefore, forecasts of potential contaminants are often inaccurate.

Future planning is unable to predict what sediment capture needs and requirements are in real-time, nor can known filtering systems fully adapt to the changing sediment filtration exchange requirements. There needs to be a solution that is adaptable as water decontamination requirements arise. Therefore, there needs to be a sediment filtration device that can be dynamically adapted to the changing sediment filtration exchange requirements in real time.

Likewise, there is increasing environmental regulation of pollutants for which there must be greater compliance. Therefore, there is a need to ensure compliance by implementing pollution control devices, methods and systems.

### Destination of Flow and Environmental Impact

Cleansing storm water runoff, or other polluted water sources, of potential contaminants needs to take into account the destination and the impact of redirecting water flow for the purpose of decontamination. For example, water flow into areas such as wetlands is critical for the native flora and fauna's lifecycle. Therefore restricting or damming water flow may restrict or damage the target, albeit a crop, wetland or other environment.

During flooding, water flow filtration points or boundaries face considerable challenges since erosion, disruption of the immediate ecosystem and/or leaching resulting in an unsafe environment that poses secondary problems. Therefore, water flow often needs to be re-routed. The ability to stop and start water flow has not been available to date in non-mechanical sediment filtration devices.

Likewise, toxins can become concentrated in the flora and/or fauna downstream, so exposure of the food chain to contaminated water may result in toxic effects that are distal both in time and geographical location, compared with the original source of the contamination. Consequently, the ability to direct flow in a flexible and dynamic manner has, to date, not been adequately overcome, to date, by sediment filtration devices. Therefore, there needs to be a sediment filtration device that can re-route the direction of water flow to ensure the intended destination of the water is enabled.

### Damming Produces Problems

The slowing of water flow for filtration purposes may result in effective temporary damning of water, which can cause back-flooding due to inadequate drainage. This results in damage to both the physical environment and often further contamination through contact with gray water and/or sewage, resulting in outbreaks of diarrhoea, dysentery and other disease resulting from polluted environments. Consequently, workflow has to be optimised. Therefore, there needs to be a sediment filtration device that can filter sediments without causing damaging damming.

### Contamination Profile

Sediment capture devices to date have struggled to cope with or treat the variety of contaminants in sediment. The ability to scale or the flexibility to adapt to changing sediment profiles and/or to capture sediments of specific particulate size and/or type/risk has, to date, been limited. Consequently, the recognition and provision of suitable means to capture sediment of specific profiles and/or to limit the risk of changing contamination profiles (as in floods where there may be, say, initial industrial waste contamination followed by later bacterial contamination), either generally and/or for specific environment needs is still not fully achieved. Therefore, there needs to be a sediment filtration device that can filter sediment contamination as it arises at different temporal stages. Further, there also needs to be contamination control devices, systems and methods that can remove a wide range of sediments, toxins and/or other forms of contaminants as required.

Pharmaceutical toxicity requires a particular mention because this is an emerging problem since pharmaceuticals are accumulating with consumption increasing and therefore excretion/disposal is also increasing within the immediate environment.

Water contaminated with pharmaceuticals is a serious environmental and human health threat due to their ubiquitous nature, ability to act on non-target biological systems and can cause chronic toxicity at low doses. The impact of pharmaceuticals on plankton and other sea life is effective at concentrations up to 200 times lower than that required for a human.

Likewise, the impact on single cell organisms, such as bacteria, is that these target bacteria are becoming insensitive to pharmaceuticals such as antibiotics. This results in the pharmaceuticals becoming ineffective. The impact on the ecosystem is that some microorganisms are becoming desensitised whilst others are annihilated. Therefore, the ecosystem's balance is disturbed.

Current wastewater plants are not designed to remove pharmaceuticals; however, new techniques have been proposed such as the use of oxidising processes, which produces reactive and oxidising radicals which degrade pharmaceuticals. The problems with these approaches are that they are too expensive.

Examples of pharmaceuticals potentially having a toxic impact (see Biodegradation of pharmaceuticals by microorganisms (2008) thesis by Hervé Gauthier, Department of Chemical Engineering, McGill University, Montreal) include the following:
1) Carbamazepine is one compound that is found to have a relatively small percentage (2%) unmetabolised when passing through urine. However the metabolites are still effective in blocking sodium channels, which are essential for cellular function.
2) The antibiotic sulfamethoxazole is widely prescribed drug effective against gram negative bacteria, which approximately 50% remains unchanged when excreted. Groundwater and streams in the US have been found to have microgram per litre concentrations of sulfamethoxazole, which is indicative of very fast increase in the environment concentration.

### Lifespan and Succession of Contaminants

Storm water run-off, or other forms of polluted water, often contains sediment including contaminants, which are environmentally dangerous. Examples of contaminants include heavy metals (arsenic, cadmium, chromium, chromate, lead, and/or mercury), common metals such as iron are also toxic in high concentrations, pesticides, bacteria, viruses, oils, and nutrients for either desired and/or non-desired species such as blue green algae/E. coli, which may take the form of environmental toxins/pollutants/health risks. These contaminants may have immediate or delayed toxicity such as contributing to the incidence of various forms of cancer.

The need to control water flow contaminated with a specific sediment (e.g. oil), chemical and/or toxin profiles has presented itself on many occasions with much public fanfare; however the solutions presented have not been able to be quickly mobilised and/or adapted to limit contamination. Sediment macrofiltration followed by chemical/toxin microfiltration, coagulation and precipitation are generally not available by conventional filtration techniques, since these needs are specialised to the situation presenting and, to date, have been poorly standardised to capture contaminated water in various filtration points or boundaries, such as at storm water entry points. Therefore, there needs to be a sediment filtration device that is adaptable to perform specific macrofiltration of sediments followed by specific microfiltration of one or more specific contaminants in a specified order.

### Physical Limitations of Options to Optimise Water Flow with Sediment Capture

Understanding water flow and sediment capture exchange has been difficult since the sediment capture devices have, to date, only poorly regulated water flow and sediment capture, since the placement of sediment filtration devices is often at the point to optimise sediment capture whilst ensuring that the device is not washed away with the water flow. Physical restraints have been imposed on where sediment filtration devices are placed. Likewise, filtration has been limited to the offerings of a standardised filter device suitable for only the most basic circumstances, as opposed to the needs of the immediate environment. Therefore, there needs to be a sediment filtration device that can be anchoured into the supporting substructure to limit the risk of being washed away.

### Cost Impediments

Another drawback of known filtrations systems, to date, is that they are prohibitively expensive. So, not only do known filtration devices lack the flexibility or scalability to provide a solution closely associated with the problem presented, they have also often been too expensive to implement. A more cost effective solution is required.

### Physical Impediments

There have not been significant developments in the sediment filtration device sector in recent times. Up until 30 years ago the standard approach to perform a sediment filtration function was by using hay bales which acted as “silt fences”, followed by implementing leaching basins and/or sedimentation tanks, retention ponds which are costly and permanent solutions formed out of concrete and/or plastic. These systems are expensive and/or insensitive to the immediate environment. Moreover, the machinery required to transport and implement such systems is not available as a dynamic and/or remote solution. Therefore, there needs to be a sediment filtration device that can be more readily transported and/or implemented.

### Exploit Flooding as a Distribution Mechanism

There have been opportunities available for beneficial exploitation where flooding has taken place. For example, the opportunity to introduce and distribute crop optimisation products via the water flow has been available. Such crop optimisation products include growth promoters and/or bacterial substrates to enhance the recipient crop's growth and/or reduce weed growth. These benefits have rarely been taken advantage of. This is because most sediment filtration products and/or water flow mediated products are standardised products to be used in standardised prefabricated water-sediment exchange routes which do not cover the variety of real-time water-sediment exchanges that coincide with individual sediment capture's environmental needs and/or goal(s).

For example, sediment filtration devices involving water-sediment exchange for a common storm water inflow, for example, “silt fences” do not allow the introduction of new or specific filter to, say, remove environmental toxins, bacteria and/or algae, which typically contaminate storm water during flooding. Therefore, there needs to be a sediment filtration device that can be used at the appropriate time to add specific desired nutrients, probiotics, bacteria etc. into the water flow to the intended location.

### Lifespan of Filtration Capabilities

Sediment filtration exchange device lifecycles are also dependent on water flow and the level of sedimentous, chemical and/or toxic contamination. That is, sediment filtration devices may have shortened life-cycles due to being over saturated with sediment and therefore not coping with the capture requirements. This may result in the filtration device providing damming rather than filtration solutions. Therefore, there needs to be a sediment filtration device that can be scaled to adjust for sediment saturation so decontamination and/or sediment removal is maintained and/or the flow of water is not impeded.

### Lifespan and Succession of Contaminants

Sediment-water exchange historically has been inflexible because sediment capture is:
1. subject to pre-specified requirements;
2. rarely updated as sediment capture requirements change;
3. limited, or has inconsistent sediment capture due to blockages; and/or
4. not scalable to be placed into all the water flow exchange routes as they arise due to variable flooding.

For example, existing sediment-water exchange systems are unable to re-route water flow, so as to direct a portion of sediment-containing water away from, say, storm water drains, or to adequately maintain filtering as water enters storm water drains when water flow changes dramatically, say during flooding.

This inflexibility often results in poor sediment capture since not all the sediment-containing water is enabled to undergo filtration. Storm water filtration points or boundaries' consequently have variable demands for which they are unable to adapt to.

Accordingly, filter devices have difficulty in meeting their core filtration function in filtering sediment in an efficient and effective manner. Thus, a filter device's resources are either under- or over-utilised due to not being dynamically adaptable or scalable to meet the variable filtration requirement conditions.

Various systems and methods have been developed to assist in meeting filter devices functions. Most focus on sediment capture against a volume of contaminated water. These systems have focused on such goals without reference to the changing sediment capture environments. For example, known sediment filtration devices, system and methods include the following:

WO 2001 002304 A1 describes an exchange of sediment-water using a sandbed and a sedimentation chamber as the means to aid exchange storm water flowing into a plurality of openings passing through the side walls of the sedimentation chamber. The removal of the environmental toxins involves a coagulation compound which oxidises and coagulates specified toxins which are embedded into the sediment capture interface which takes the form of a sandbed. However, the system of WO 2001 002304 suffers from the disadvantages that it relies on a sedimentation chamber, which is of a limited volume (pre-set structure) and therefore limited in its ability to deal with, for example, flooding.

WO 1995 021798 A1 provides a prefabricated tank which treats storm water by employing oil and grease separation and filtration from inflows; however, there is no interface to involve the capture of new filtration targets in line with a change in environmental needs, since the tank is of a uniform structure with a preset presumed function.

US 2003 0220884 A1 provides a system and method for contamination remediation exchange to be performed by a storm water drains and/or waterway cleansing where water flow to sediment capture and/or person to person contamination remediation systems exchange can be performed; however, the product offerings are not able to be aligned with specific sediment capture's requirement(s).

U.S. Pat. No. 7,101,115B2 relates to a contamination remediation system enabling hydrophobic organic contaminants (HOC) that are bioavailable to be exchanged, so as to reduce the release of HOCs into water or to be uptaken by biota, thus reducing environmental exposure.

2002100944 is for a sediment filtering and/or settling apparatus using a using filter fabric placed over a frame structure to perform sediment filtration.

The disadvantage of these systems is that while they suggest to how to perform water-sediment exchange, say to apply along watercourse, they do not assist a sediment capture where water flow is dynamic, that in performing an independent placement of the sediment filtering apparatus, the apparatus may be washed away such that the water flow will just be re-routed around the sediment filtering apparatus so as to make the apparatus obsolete so the purpose of the apparatus becomes negligible as an effective solution.

It would be useful to have a sediment filtration device that assists sediment-water exchange at specific physically nominated positions and/or decontamination steps so that filtration is optimised.

It would be also useful to have a sediment filtration device to assist water flow in a manner scalable to the environmental need.

It would be also useful to provide a sediment filtration device, system and method that assists sediment capture whilst maintaining water flow needs based on exchange requirements between water flow and sediment capture at one or more nominated positions along the watercourse.

It is an object of the present invention to seek to overcome or substantially ameliorate at least some of the deficiencies of the prior art, or at least to provide a useful alternative.

### SUMMARY

The present invention is related to a device, method and system for fluid decontamination. This fluid decontamination device, method and system, contains a Reactive Filter media termed RFM which in a further embodiment of the invention is preferably insertable into a device, termed a RACS, which is formed from the acronym Reactive filter media Attachment Compartment Sock (RACS) encompassing the following features:
1. Reactive Filter Media (RFM) formed from a Design Mix Configuration (DMC) designed to decontaminate polluted fluid such as stormwater/runoff/industrial by product waters specifically or broadly depending on the decontamination requirements, preferably with one or more of the following features to meet environmental conditions requirements:
2. One or more Attachment means located on the outer surface of the sock, sack, filterbale and/or filtersack (hereafter Sock). One or more attachment means(s) allow the sock(s) to be easily connected to each other, carried to site, and/or Sock to be physically anchored into a supporting substructure (such as the soil). This prevents the Sock from being carried along with the flow of the contaminated water. Alternatively, or in addition, a plurality of attachment means are enabled to take the form of attachment handles on a plurality of Socks can be aligned so that the alignment of attachment handles is capable of receiving a post, star picket, anchoring pole or the like (made of metal, carbon fibre, graphene or other suitably strong material). This allows the plurality of socks to be reversibly engaged in alignment;
3. Compartment(s) for receiving insertable and interchangeable contents (namely, reactive filtration media selectable for microfiltration) within a Sock which may take the form of a sock, sack, filterbale and/or a filtersack unless otherwise specified. When there are two compartments within a sock, filterbale and/or a filtersack this is referred to as a dual Sock, which are selected to physically, chemically and/or biologically treat contaminated fluid in a stepped fashion, where the first compartment has a reactive filtration media selectable for microfiltration of, for example, contaminant X, followed by the second compartment containing a different reactive filtration media selectable for microfiltration of contaminant Y. This series of compartments can be increased in number to meet the number of steps required to decontaminate contaminated fluid. The compartment is reversibly sealable to contain the microfiltration content once inserted for as long as efficacious. Depending on the specific circumstances, the content (the reactive filtration media) placed within the compartment can be loosely or tightly packed. The degree of structural rigidity of the overall RACS is achieved through packing of contents into each sock, filterbale and/or filtersack and can be varied at different points within the “skeleton”. This allows the RACS to sit along irregular surfaces and to bend when and where necessary. When there are two compartments within a sock, this is referred to as a dual sock; and/or
4. a Sock (including a sock, sack, filterbale and/or a filtersack) is in the form of an outer skin, so that the sediment filtration device consists of an outer bag structure. This outer skin provides macro-filtration of sediments as the contaminated water flows through the sock. A Sock has a greater surface area contact than known sediment control devices; thereby reducing the potential for runoff to create rills under the device and/or create channels carrying unfiltered sediment. Inside the Sock sits insertable and interchangeable reactive filtration media. This reactive filtration media perform microfiltration as contaminated water flows through the inner compartment of the tubular bag in the case of a sock or a sack. A Sock in its variety of forms filters contaminated water on a macro- and micro-level. Socks are “stackable” in a plurality of directions and have an advantage of being capable of being stacked to form a “skeleton” (physical structure). This skeleton directs the flow of water since Socks are generally placed perpendicular or tangential to sheet-flow runoff to control erosion and retain sediment in disturbed areas. The difference between a sock, sack and a filterbale or filtersack is that filterbales and filtersacks have a more rigid frame structure, enabling it to filter higher contaminated fluid flows.
Filtersacks don't have a rigid frame but are generally contained inside a rigid frame device e.g. Reactive Filter Unit. A Filtersack is not generally tubular.

### DETAILED DESCRIPTION

The invention provides a new or alternate sediment filtration system, device and method, referred to as a RACS, which assists water flow filtration, decontamination and/or remediation at suitably positioned filtration points.

For a better understanding of the invention and to show how it may be performed, a preferred embodiment will now be described, by way of non-limiting example only, with reference to the accompanying drawings and example.

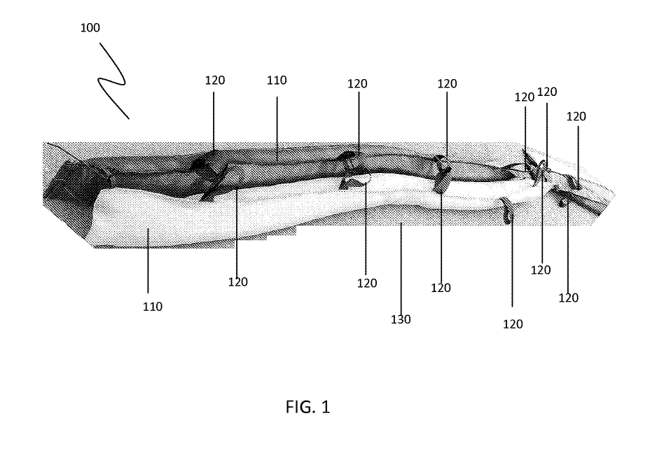

FIG. 1 is an exemplary RACS according to a further embodiment of the invention.

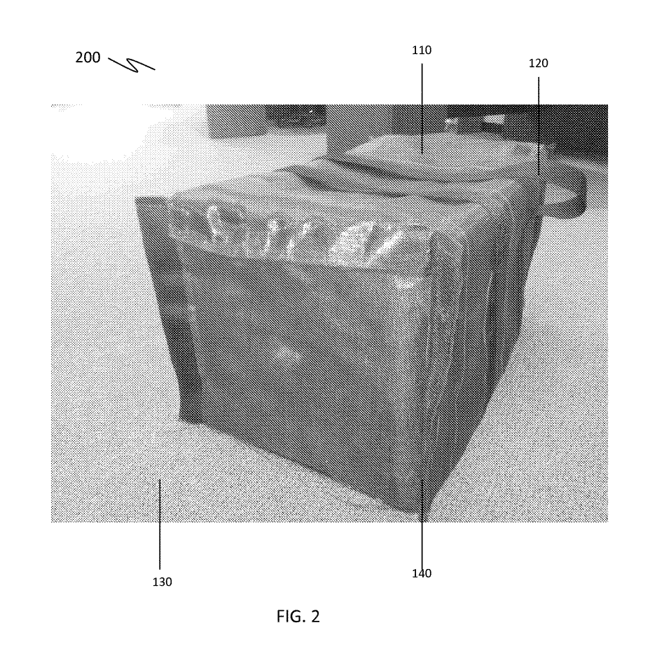

FIG. 2 is an exemplary RACS according to an alternate embodiment of the invention.

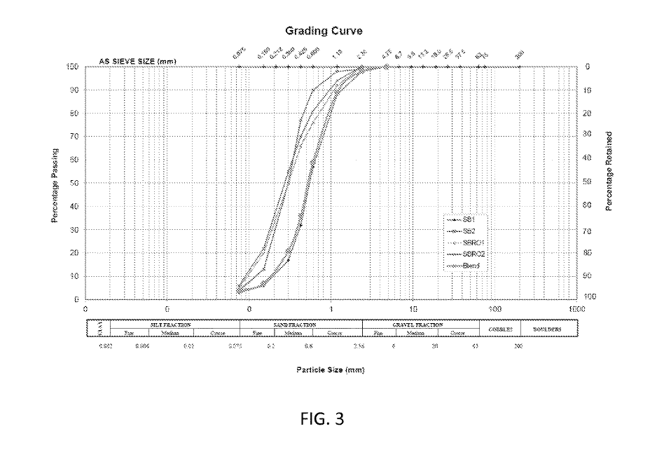

FIG. 3 is an exemplary grading curve for a selected variety of Reactive Filter Media (RFM) according to an embodiment of the invention.

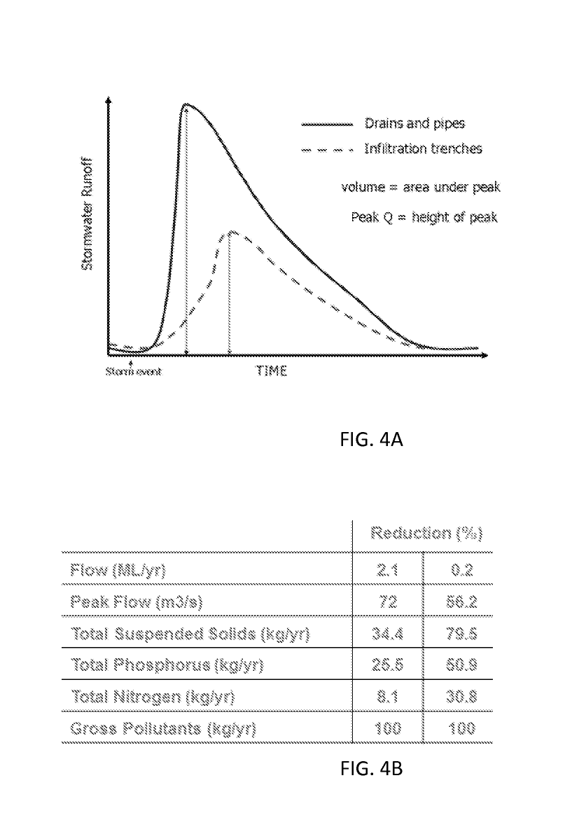

FIG. 4A is an exemplary storm time-water runoff curve for a selected RACS compared to the absence of a RACS according to an embodiment of the invention.

FIG. 4B is an exemplary table for a selected RACS showing the extent of reduction of flow and pollutants into a drain compared to the absence of a RACS according to an embodiment of the invention.

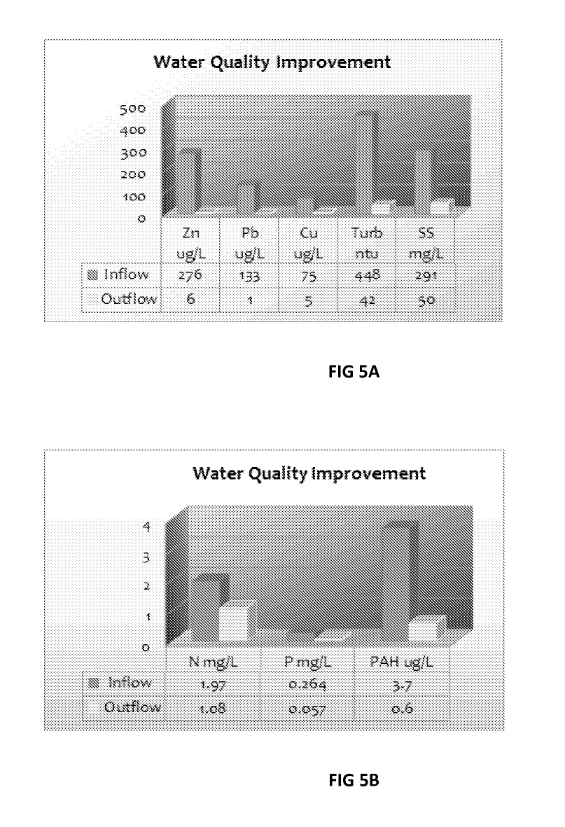

FIG. 5A is an exemplary water quality improvement graph for a RACS selected to filter the metals Zn, Pb, and Cu showing inflow and outflow according to an embodiment of the invention.

FIG. 5B is an exemplary water quality improvement graph for a RACS selected to filter N, P, and PAH showing inflow and outflow according to an embodiment of the invention.

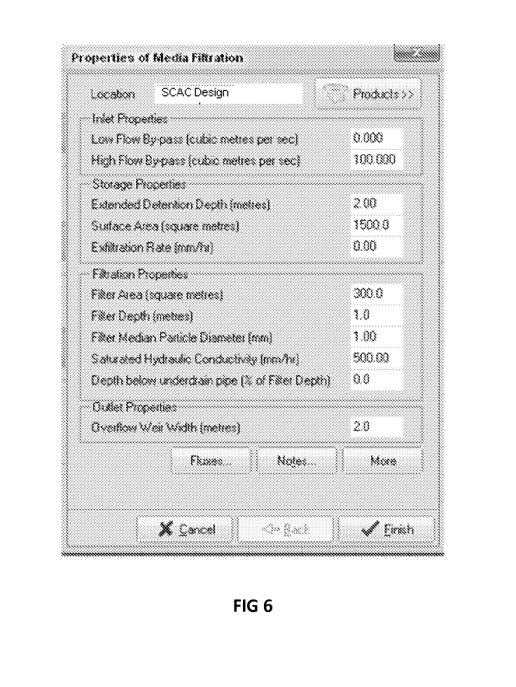

FIG. 6 is an exemplary RACSs sock material and medium modelling tool to reveal the filtering rates compared to size using a computer enabled design system to design bespoke reactive filtration media according to need according to an embodiment of the invention.

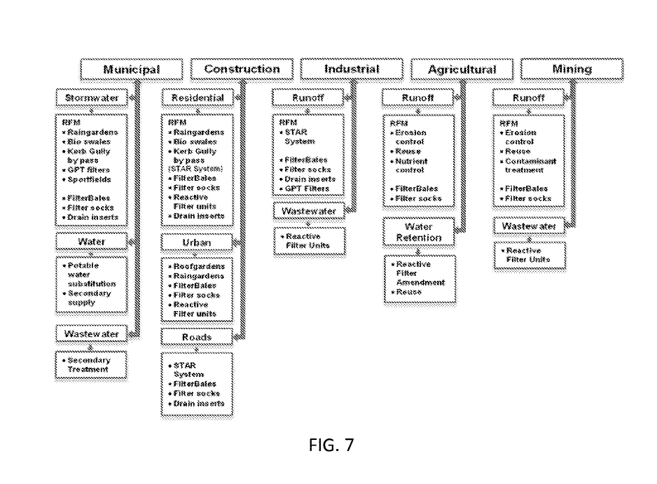

FIG. 7 is an exemplary RACSs application tool which compares alternate applications and possible secondary requirements/uses according to an embodiment of the invention.

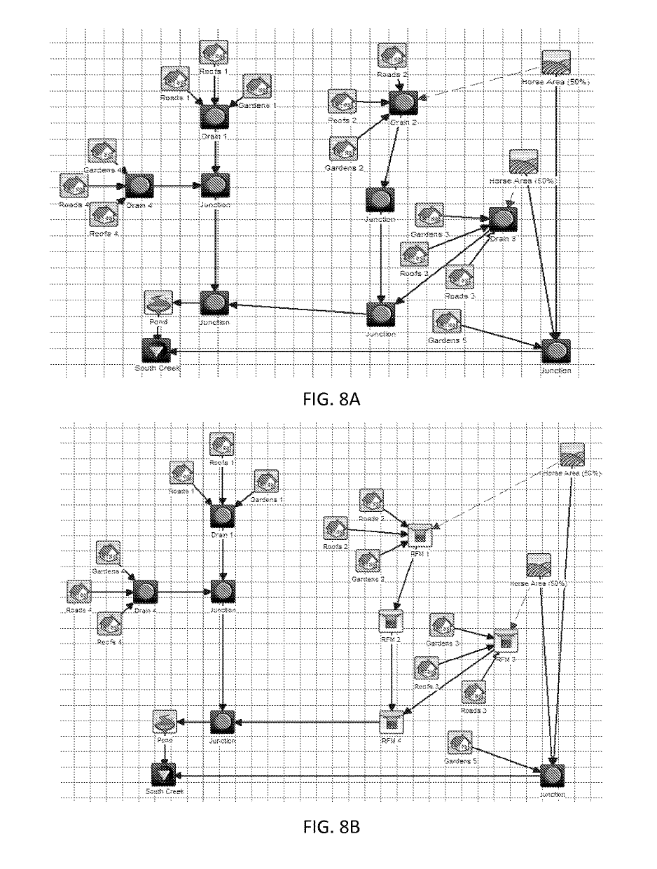

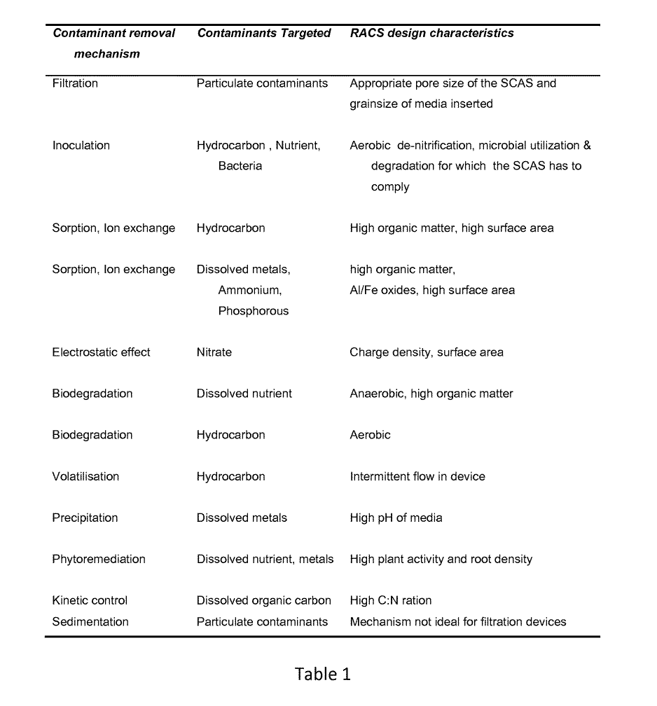

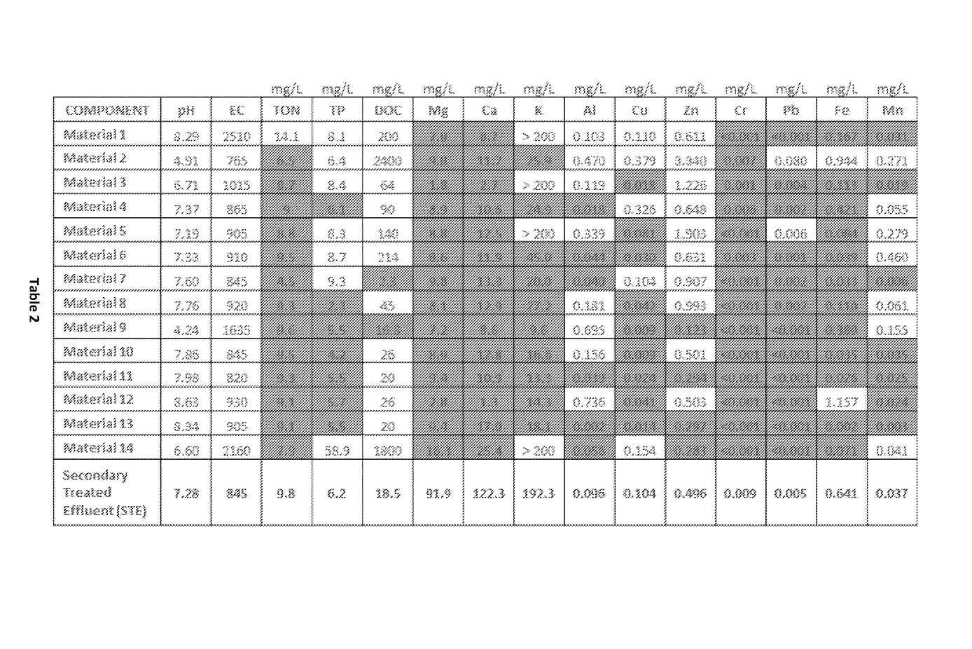

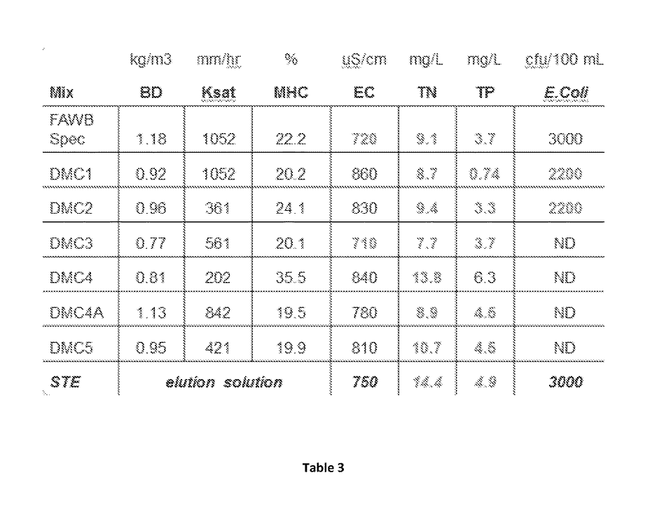

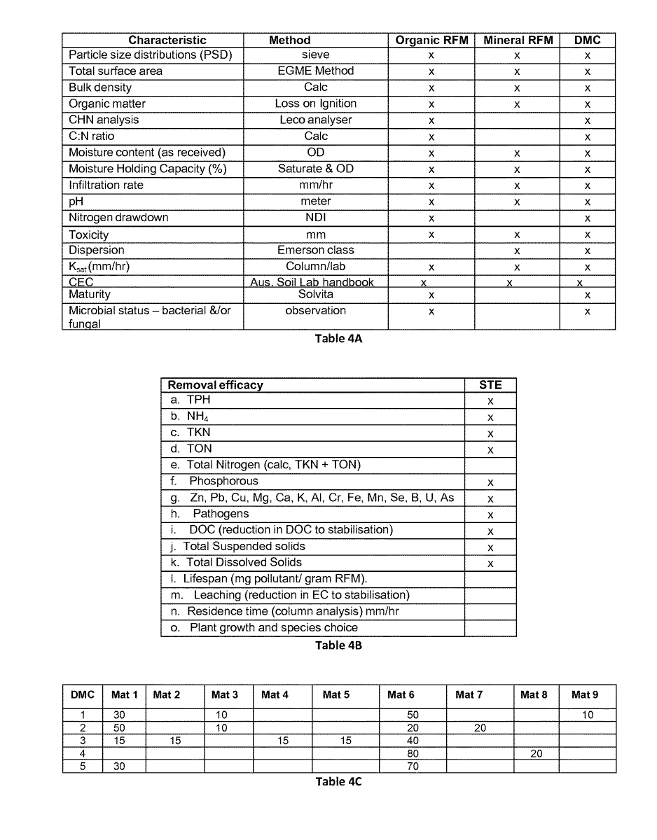

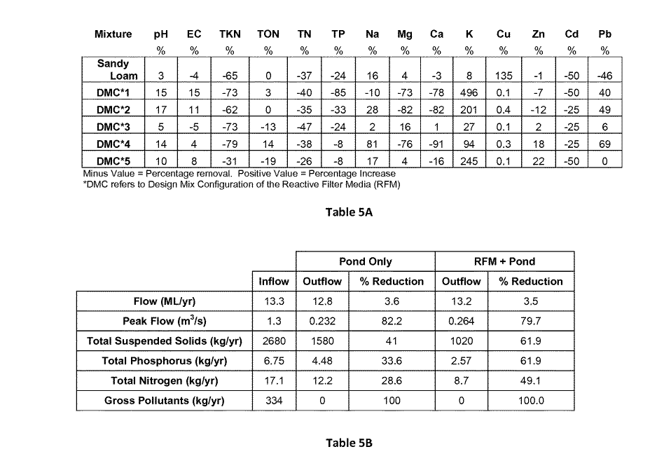

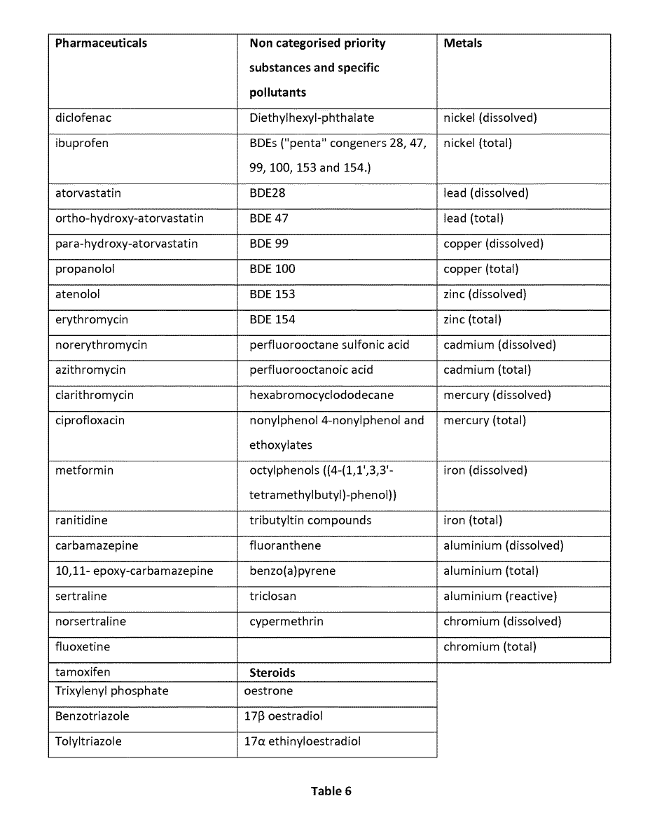

FIG. 8A 8B is an exemplary treatment train generated by the computer RFM design module showing an optimise path for placement of RACS without the presence of Reactive Filter Media (RFM) according to an embodiment of the invention.

FIG. 8B is an exemplary treatment train generated by the computer RFM design module showing an optimise path for placement of RACS containing RFM as opposed to having no RFM according to an embodiment of the invention.

TABLE 1 is an exemplary table showing the contaminant removal mechanism for specific contaminants to be selected when passing through a specified RACS according to an embodiment of the invention.

TABLE 2 is an exemplary table showing the contaminant removal contained within a specified RACS for specific filtration qualities according to an embodiment of the invention.

TABLE 3 is an exemplary table showing the reactive filtration mediums as modelled by performance attributes contained within a specified RACS for specific filtration qualities according to an embodiment of the invention.

TABLE 4A is an exemplary table showing the individual reactive filtration media characterisation parameters as modelled by given threshold performance attributes contained within a specified RACS for specific filtration qualities according to an embodiment of the invention.

TABLE 4B is an exemplary table showing the individual reactive filtration media used to describe the removal efficacy performance by specific variables when contained within a specified RACS for specific filtration qualities according to an embodiment of the invention.

Table 5A is an exemplary table showing a percentage change in contaminant removal concentrations using five sample Design Mix Configurations (labeled as DMC) according to an embodiment of the invention.

Table 5B is an exemplary table generated by the computer RFM design module showing a percentage reduction in the presence of a RFM as opposed to having no RFM according to an embodiment of the invention.

TABLE 6 is an exemplary table showing the targets of reactive filtration media design mix configurations when targeted for treatment/removal and/or cultured with bacteria and/or fungi according to an embodiment of the invention.

### Definitions

Sediment and/or contamination are used within this patent to generally include silt, suspended solids, dissolved solids, pollutants, dissolved and particulate sediments, contaminants and/or contamination by undesired substances including oils, toxic compounds, metals, nutrients, algae, bacteria, chemicals, pharmaceuticals and so on, unless otherwise specified when referring to a specific item.

Sock is used within this patent to generally include socks, sacks, filtersack, filterbales, filtersack and/or reactive filter units unless otherwise specifically referred.

The elements of the invention are now described under the following headings:

### DETAILED DESCRIPTION OF A PREFERRED EMBODIMENT

In the preferred embodiment, the RACS system, method and device comprises Reactive Filter Media (RFM) formed from a Design Mix Configuration selectively and specifically designed to perform chemical, physical and/or biological filtration to remove specifically selected contaminants when polluted fluid passes through the RFM.

Reactive Filtration Media Design and Selection

The RFM, when selectively designed, engineered, manufactured and supplied to decontaminate a specific or generally contaminated fluid takes the form of a selectively designed RFM that physically, chemically and/or biologically treats specifically selected contaminants, or generally a broad selection of contaminants, from contaminated fluid passes through the RFM formulation. This contaminated fluid may have previously been analysed to determine the likelihood of which specific or broadly associated contaminates are present.

For example, cadmium may be known to be likely present in industrial waste environment since it is one of the major elements contained in solder and electroplating. Cadmium is toxic, carcinogenic and teratogenic and accumulates in the body; therefore it is important to remove cadmium from contaminated fluid from such a flooded industrial site.

An RFM is enabled to be specifically designed to contain cadmium exchange compounds such as calcium in the forms of calcium carbonate and other calcified products. The inclusion in an RFM is designed to provide a reactive surface for which the contaminated fluid can pass through, so as to enable the exchange of cadmium for calcium in whatever chemical species it resides, so the cadmium is removed from the fluid. Likewise, salts such as ferric and/or ferrous oxide/chloride be also used to remove metals with higher toxicity.

It will also be appreciated by those skilled in the art that contaminated fluids rarely contain contaminants in just a simple salt form. For example, a heavy metal contaminant may take the form of being in a variety of different species, including both inorganic and organic forms, so that, for example, divalent cations may take many forms.

Table 1 shows a series of considerations taken into account when designing and selecting a RFM to filter one or more pollutants. Table 2 shows a series of RFMs, referred to as materials within Table 1, which are designed to have unique qualities to capture specific ions and pollutants at a rate of milligrams per litre.

The RFM when specifically designed may be used a chosen blend of components to meet specific objectives. For example, Table 3 shows a series of RFMs that have different DMCs, so that one or more RFMs are engineered for specific performance requirements such as contaminant removal, lifespan, hydraulic conductivity and compaction. These qualities are shown in Tables 1 and 2.

Treatment by an RFM of specific DMC is enabled to decontaminant contaminated fluid by using specific chemical, physical and biological processes created to act through the design of the RFM. The RFM decontamination methods, including those shown in Table 1, are, for example, methods such as:
1. Sorption, where a physical and chemical process is used so that one substance becomes attached to another;
2. Ion exchange;
3. Precipitation;
4. Volatilisation;
5. Microbial biodegradation;
6. Phytoremediation.

The RFM(s) are also designed and selected to minimise the environmental risks associated with infiltrating contaminated fluid by effectively and efficiently removing contaminants. The RFMs may be inserted at site or transported with the RACS (discussed below as a further embodiment) as the containment means ready for implementation.

### RFM Exemplary Mechanism of Action

Reactive Filter Media have a variety of mechanisms of action including the decontamination of metals as discussed previously. To extend our previous example of cadmium in the industrial estate environment:

Cadmium in this environment may take the form of cadmium chloride (CdCl2), methyl cadmium (CH3 CdMH3), in its ionised form Cd2+ and/or its metallic form due to the other contaminants within the fluid. Therefore it is important to capture cadmium using a variety of methods including ion exchange, chelation, precipitation, filtration, floccution using the appropriate clarifying agents and/or absorption/sorption (the removal of undersaturated solutes, where the solutes are the contaminants) from a contaminated fluid.

The RFM(s) required are designed and produced to filter particular contamination profiles in specific environments including RACSs containing designed RFM(s) for industrial estates, RACSs containing eco-friendly media for landscape gardens, RACSs for retaining walls, roof gardens (the total weight may be critically important in these environments and so a lower weight RFM is selected), sports fields and leach drains, which are designed to contain free draining biochemical media to physically, chemically and/or biologically treat effluent and drain fluid. Leach drain RFM bio-remediates accumulated toxins contained in run-off. The fluid is can then be passed through RFM drainage cell systems for re-use.

The RFM selected for insertion into one or more Sock compartments enables the RACS to act as a filtration systems for the physical, chemical and/or biological treatment and reuse of stormwater runoff. The selection of filter media to specifically physically, chemically and/or biologically treat polluted stormwater to:
1. remove pollutants;
2. reuse of fluids such as water;
3. enable harvesting of nutrients, and/or
4. enable decontaminated fluids be safely discharge into waterways.

These actions are governed by the selection of one or more RACSs, the RACS(s) configuration and/or the selection of filter mediums which include RFM (RFM) which are designed for the specific environmental circumstances.

Reactive Filter Media Component Materials

Typically, an RFM is formed from the following exemplary component materials; however, the RFM is not limited to these components.

Carbon Based Components:
1. Sawdust
2. Coir peat
3. Bio char
4. Bark fines
5. Timber/Wood fines
6. Ash
7. Charcoal
8. Soil

Aggregates:
1. Fine sand
2. Medium sand
3. Foundry sand
4. Basalt dust
5. Glass fines
6. Zeolite (fast reaction time, nutrient targeting)
7. CaCO2 (OMYA Marble chips “000”)
8. Pumice
9. Other: (zero valent iron)
10. Stable Clay (e.g. bentonite etc.)

Inoculants:
1. Bacterial treatment
2. Hydrocarbon treatment

### Reactive Qualities of a Reactive Filter Media

The RFM is selected to capture and/or exchange contaminants contained within the fluid passing through it. The RFM's contaminant removal can take place via filtration, chelation, absorption, flocculation (colloids come out of suspension is a precipitate in the form of floc or flake), exchange and/or via a variety of other methods discussed below and/or considered by person skilled in the art.

Screening to Select the Most Suitable Reactive Filter Media

One or more target contaminants are enabled be selected, from RFM and/or directly from contaminated fluid, by screening as the flow of contaminated fluid has the contaminants collected for sampling.

Initially, a broad-spectrum RFM may be utilised and analysed for contaminants present until a more specific RFM is nominated after analysis. This analysis is performed to enable the contaminated fluid to be matched with the most suitable RFM available to perform decontamination. That is, the RFM is selected to perform outcome based decontamination based on criteria including contaminants contained (phosphorous, nitrogen, suspended solids and/or general pollutants), flow rate, and other contaminant attributes are shown in FIG. 4. An RFM's decontamination is to remove contaminates to an acceptable threshold level, dependent on the environmental standards required and/or a preferential level for subsequent decontamination.

This method of matching RFM to contaminants requiring removal enables the quantification and a selective targeted approach to remove contaminants in a determined prioritisation approach from the most dangerous to the least dangerous contaminants if required. This may also involve the use of several reactive filer media(s) in series and/or in parallel as discussed further below.

The analysis above enables the selection of one or more RFMs by their reactive surface, absorption qualities and/or composition so as to remove particular contaminants.

### Computer Aided Reactive Filter Media Design and Selection

The characteristics, behaviours and/or life cycle performance of RFMs are quantified and qualified by each RFM's efficacy data with respect to a specific contaminant requiring removal in a specified environment. Table 2 shows the activity of a specific RFM when exposed to a secondary treated effluent (STE). The removal of nitrogen and phosphorous in its various forms as well as the removal of metals, solids and other components to a significant threshold level enable characterisation of an RFM in the form of a codified sequence of actions.

When a significant collection of RFM activities have been codified, an algorithm of activity is enabled to be generated for decontamination in one or more specified environments. This data and accompanying algorithms are enable to be utilised further by a computer RFM design module, which subsequently is enabled to perform actual, modelled and predictive analysis of one or more RFMs' suitability for use in a specific environment.

This provides current and predictive performance models for use in designing further RFMs according to DMC. These RFM DMCs are designed to achieve specific decontamination and to meet specific performance thresholds when subjected to contaminated fluid in one or more specified environments according to an array of criteria including internal decontamination targets and/or external considerations including availability, cost, environmental suitability, degradability or other considerations that may be consequential when selecting RFMs.

One or more RFMs are enabled to be selected from a catalogue of RFMs characterised by their physical/chemical/biological properties and their related performance efficacy in decontaminating fluids in specific environments and/or hypothetical environments so that suitable RFMs are available when, say, a hundred year flood occurs.

The computer RFM design module is also enabled to aid RFM selection for preferable RFM characteristics as shown in FIG. 6, to treat contaminated fluid under specified conditions as shown in FIG. 7 and/or modelled, as shown in FIG. 8.

In a further embodiment, RFM DMC and production is enabled to target specific contaminants using the computer enabled RFM design module. This module performs analysis of one or more of the following:
1. contaminants present in a fluid (or as a modelled scenario); and
2. characteristics and behaviours of:
   a. RFMs available, so as to match treatment requirements to the most suitable RMF available; and/or
   b. designs to produce a specific RFM to perform a specific decontamination task.

The RFM design characteristics are selected by the RFM design module include, for example, the following:
1) Saturated Hydraulic Conductivity, where, for example, a specific saturation may be specified, such as 133 mm/hr or alternately, a range is enabled to be specified, for example, from 70 mm/hr to 180 mm/hr,
2) Total Nitrogen (TN) content of RFM, for example, <220 mg/kg (note: in this specific case, TN >400 mg/kg is recorded via techniques consisting of TN leached into a receiving node);
3) Proportion of Organic Material is enable to be specified, such as <5%;
4) Orthophosphate Content of Filter Media, for example, <55 mg/kg; and
5) Porosity of media, for example, =0.4 (or in a specified range from 0.3-0.4).

These criteria are enabled to be read from a catalogue of RFM characterisation parameters such as those contained in Table 4A, which further reveals the method of testing for such characteristics. Likewise, Table 4A further reveals the configuration of an RFM as an organic RFM, a mineral RFM and an RFM that is a design mix configuration of a combination of organic, mineral and/or other RFM types.

RFM design characteristics selected by the RFM design module achieves specified targeted outcome are also enabled. The performance variables of a specific RFM is shown in Table 4B.

### RFM Material Characterisation

A typical RFM material characterisation includes the following data:
1. pH
2. particle size grading, which includes aggregate standard sieve sizes in the range of 0.01 to 10 mm
3. CeC
4. Porosity
5. EC
6. Dispersion (Emerson class)
7. Chemical analysis
8. Maturity
9. Microbial population (bacteria/fungi)
10. Carbon—stable, labile or Ligin, Cellulose—
11. CHN analysis—
12. C:N ratio
13. Bulk density
14. Water holding capacity

The analysis of the contaminated fluid includes analysis of contaminants that are:
1. Particulate
2. Dissolved
3. Soluble

Analysis of RFM for the removal of contaminated fluid is performed with respect to the extent of anolytes and catolytes present, including the following:
1. BOD (or CBOD5)
2. TKN (NH4 & NO3)
3. TP (Particles, dissolved, soluble)
4. E. coli
5. pH
6. EC
7. TSS
8. Metals
9. Hydrocarbons
10. Btex.

These tests enable the removal of known and unknown pollutants contained contaminated fluids flowing through, for example, industrial estates. These scenarios often involve urgent physical, chemical and/or biological decontamination. Here, a specific RFM is often required if, for example, the contaminated fluid contains toxic metals.

### Reactive Filter Media Design Mix Configuration by Targeting Actions

Reactive filter media design mix configurations, such as the five DMCs contained in Table 3, for example, are enabled to meet targeted contaminant reduction requirements of a STE, under specified environmental parameters, such as the following:
1. 80% Total suspended solids (TSS),
2. 60% Total Phosphate (TP), and
3. 45% Total Nitrogen (TN).

The RFM design module is enabled to further specify the following indicative contaminant removal properties per cubic meter of contaminated fluid:

1. Total Nitrogen (TN) content: 240 mg/kg

2. Orthophosphate content: 33 mg/kg

3. Saturated hydraulic conductivity: 70 mm to 180 mm/hr

4. Proportion of organic matter: less than 5% by weight

5. Air filled porosity: 0.3 to 0.4

6. Total suspended solids (TSS) reduction: 83%

In one arrangement of this embodiment of the present invention, the contaminant analysis collected, such as toxin and/or bacterial contamination, is processed to produce a series of RFMs that are used in a stepwise decontamination process dependent on the prioritisation of most dangerous contaminants to be removed.

That is, each contaminant may have a severity of harm, so that when detected and ranked using a contaminant harm indicator weighting analysis, the RFM design module will initially produce one or more RFMs to decontaminate the most harmful contaminant(s) as prioritised using the RFM design module. The RFM design module will initially seek to remove all contaminants in a one-step sequence first. However, if this is not possible, the RFM design module then seeks to first decontaminate the most harmful contaminant(s), followed by decontaminating the next most harmful contaminants, et cetera, using a series of decontamination steps.

An RFM may be designed and/or selected to remove metallic contaminants may also need to screen the contaminants to preferentially remove the most toxic contaminant and exchange it for a less toxic contaminant. That is, there is a complex matrix of activities that need to be assessed so that the actions on, for example, one high priority toxin does not impact on anther high priority metal also requiring decontamination. The mechanisms of action of an RFM must not tackle one priority whilst letting another contaminant becoming, for example, less accessible or more harmful. Therefore, the impact of selective contaminant reduction must also assess the changed environment and this altered environment's impact as far as potential impact.

Consequently, a RFM DMC is designed to be able capture the most dangerous contaminants if possible in parallel and to optimise the resulting environment to be the safest achievable environment and/or to insert new RFM DMCs if necessary to remove further contaminant(s). Likewise, RACSs such as dual socks and sacks may also be used as discussed further below.

### Reactive Filter Media Fluid Decontamination

The RFM mechanism of action and behaviour considerations that are taken into account to obtain RFM performance attributes are included in Table 1. This enables the following RFM performance objectives of fluid decontamination to be classified by criteria including the following:
1. Identification of the quantity of each pollutant identified and removed;
2. quantification and qualification of hydrocarbons elimination;
3. quantity of RFM required per unit flow of pollutant;
4. lifespan of RFM—replacement/amendment requirements;
5. contact time/conductivity/treatment performance relationships of RFM surface area per unit flow of pollutant; and
6. lifecycle leaching behaviour.

These performance criteria are specific to RFM performance factors (not prioritised) including the following:
1. Component selection & proportions
2. Particle size/surface area
3. Carbon fraction content
4. Moisture Holding Capacity/porosity
5. Cation Exchange capacity and/or charge density
6. Sorption
7. Nitrogen drawdown
8. pH
9. Stability/Structural Integrity
10. Leachability
   a. Nutrients
   b. DOC
11. Flow rate of influent
12. Permeability
13. Hydraulic conductivity (residence time, reaction time)
14. Dispersability
15. Bulk density
16. Wettability
17. Toxicity
18. Maintenance
   Availability & cost
   Safety
   Phytoremediation

Reactive Filter Media Design Module

The design of RFMs via the RFM design module (see FIG. 6) uses performance modelling as shown, for example, in Table 3.

Table 3 shows a series RFMs (nominated as DMC1 to DMC5) selected by performance output as modelled. The qualities of each RFM nominated in this performance modelling include the features as shown in Table 3:
1) density of material (BD) which is the RFM's weight in kilograms per volume of RFM in metres squared;
2) Ksat is a degree of hydraulic saturation, which is the flow of fluid through the RFM. This is dependent on the pore size, ionisation and degree of saturation of the RFM;
3) MHC is the measure of Moisture Holding Capacity which highlights moisture contained by the RFM;
4) TC is total carbon present;
5) TP is total phosphorus present;
6) TN is total nitrogen present, and
7) E. Coli is measured in the number of CFU (colony forming units) contained within 100 mls of contaminated fluid.

This modelling is essential to place the correct RFMs into locations, as those modelled to decontaminate fluid in a specific environment such as that shown in FIG. 8 (as modelled from real data in the RFM design module).

### Reactive Filter Media Design Methods

Selecting a suitable RFM to incorporate into one or more Socks (discussed further below) to provide a RACS (also discussed further below) that has sufficient decontamination efficacy is enabled by performing the following:
1. characterise the composition and volume of the contaminated fluid to be treated; then
2. create an RFM consisting of components that treat the contaminated fluid to meet acceptable decontamination values.

Reactive Filter Media (RFM) models are designed through one or more of the following steps:
1. assess one or more selected RFM varieties performance using batch testing techniques to:
   a. measure the RFM's ability to achieve acceptable contaminated fluid treatment(s) in terms of qualitative and quantitative results by:
      i. identification, quantification and validation of RFM component(s) decontamination efficacy by decontaminating fluid as classified by:
         1. mechanisms of action(s); and
         2. behaviour of such actions,
under specified (controlled) conditions;
2. extrapolating these contaminated fluid treatment in the form of decontaminating results from the batch tests to provide predictability of:
   i. mechanisms of action(s); and
   ii. behaviour of such actions,
under specified conditions that reflect possible environments that a RFM would be exposed;
3. evaluate RFM performance using column leaching techniques to characterise one or more RFM components, and in the case of a plurality of RFM components, use selected mix design configurations to quantify and qualify column leaching techniques test results; and
4. generate functional and predictive algorithms, using existing data and results from batch and column leaching tests, to provide a computer mediated modelling of:
   a. RFM mechanisms of action/behaviours; and/or
   b. RACSs containing selected RFMs of action/behaviours
under chosen environmental conditions.

This modelling uses baseline data of RFM performance on a range of RFMs actions on contaminated fluid treatment, so as to select the most suitable RFM designs and/or RFM design mix configurations to achieve specific pollutant(s) removal from specified, typical and/or possible contaminated fluids.

Reactive Filter Media Mechanisms of Action and Behaviours

Each RFM has attributes in the form of mechanisms of action(s) and/or behaviours under specified conditions. This enables an RFM to be selectable so that it is enabled to decontaminate according to quantitative and qualitative criteria by absorbing or transforming pollutants, retaining suspended sediment and/or improving infiltration rates.

Each RFM is initially tested for pH, particle size attributes, cation exchange capacity (CEC), porosity, bulk density, C:N ratio, carbon content and nitrogen content (et al see table 4A) in order to characterise the media. This is then followed by specific batch and column leaching techniques under specific conditions to demonstrate removal other selected contaminants.

For example, contaminated fluid in the form of stormwater in specified environmental conditions is initially characterised by chemical analysis for total suspended solids (TSS), nutrients (N and P), dissolved organic carbon (DOC), metals, hydrocarbons (TPH and BTEX) and faecal contamination (using E. Coli as an indicator). If required, the stormwater is able to be spiked with specific pollutants (in some cases uses secondary treated effluent (STE) to provide all parameters for the batch tests and column leaching experiments

This provides the details as to the performance of an RFM in the presence of a contaminated fluid, in this case stormwater/STE. Here, the contaminated fluid provides an analysed and/or determined chemical composition, so as to provide the determination of an RFM's:
i. mechanisms of action(s); and
ii. behaviour of such actions,

under specified conditions.

An RFM's relationship to specifically decontaminate polluted fluid, in the form of stormwater/STE/Industrial runoff, is determined by performing one or more of the following steps:
1. analysis of the contaminated fluid, such as stormwater, is performed to assess one or more decontamination targets and the environmental considerations as to how to remove the decontamination targets;
2. analysis of each RFM's performance using batch and/or column testing to establish individual characteristics of each RFM;
3. analysis of each RFM's performance attributes with regard to RFM's:
   a. specific pollutant(s) removal per unit of surface area; and/or
   b. lifespan of each RFM's ability to contain one or more specific pollutant(s), etc.;
4. analysis of mixed RFMs to provide suitable design mix configurations (DMC) using batch/column testing to establish the characteristics of mixed RFMs;
5. analysis of mixed RFM performance attributes with regard to mixed RFM's lifespan, specific pollutant(s) removal per unit of surface area of mixed RFMs, etc.,
6. analyses of individual and/or RFM design mix configurations performed using column leaching tests; and/or
7. extrapolation of one or more RFM configurations with respect to its mechanisms of action and behaviours for a given RFM surface area or footprint under a specified range of environmental conditions so that predictive performance is enabled to be extrapolated under different environmental conditions and for broad-spectrum and/or specific pollutant decontamination.

The detail of the batch testing as performed in the above steps is now discussed.

### Batch Testing

The batch testing is based but not limited to the following:
1. Protocols:
   a. ASTM, D 4319 (2001) Standard Test Method for Distribution Ratios by the Short-Term Batch Method
   b. ASTM D 5285 (2003), Standard Test Method for 24-Hour Batch-Type Measurement of Volatile organic Sorption by Soils and Sediments
   c. ASTM E 1195 (2001) Standard Test Method for Determining a Sorption Constant (Koc) for an organic Chemical in Soil and Sediments
2. Solid to liquid ratios—1:2 & 1:10
3. Duration—0.5, 1, 2 & 12 hours, material specific and extended for Anolytes, which are material specific.

The RFM mix design configurations are selected based on pollutant removal performance provided by the individual and/or batch test data results as, for example, shown in Table 5A.

Column Leaching Testing

Column tests are used on RFM DMCs to obtain the following data:
1. breakthrough data (when does one or more contaminants breakthrough the threshold RFM decontamination) for anolytes and other contaminants according to a specified sampling frequency & method;
2. toxicity data characteristic leaching procedure (TCLP) for anolytes and other contaminants according to a specified sampling frequency & method, and
3. Phosphorous Retention Index data.

Column leaching testing using contaminated fluid, such as stormwater, have columns packed to a known bulk density and pore volume prior to the leaching test. Column leaching tests on RFMs of specific DMCs provide pollutant removal performance under constant-head and falling-head conditions.

The column tests used different hydraulic heads (constant and falling) to investigate the likely in-situ performance of the RFM DMCs.

For example, column tests are an open system test indicate how an RFM would behave under:
1. high flow conditions (saturated, low residence time); and/or
2. low flow conditions (un-saturated, high residence time).

Nutrient analysis received for the column, as shown in Table 2, Table 3 and Table 5, include the following quantitative data for:
1. Total Kjeldahl Nitrogen (TKN),
2. Total Oxidisable Nitrogen (TON),
3. Total Phosphorous (TP),
4. Total Nitrogen (calculated as TKN+TON), and
5. Metals analysis comprised of Ca, Na, Mg, K, Cu, Pb, Zn and Cd.

### Column Leaching Testing Method

Constant-head conditions used 1 L of secondary treated effluent (STE) poured into the top of the column, where the top of the column contains a “head” and at this time the volumetric flask is quickly inverted and the spout submerged in the STE above the RFM DMC in the column. The volumetric flask is clamped in place and the STE moves through the column under gravity.

The time taken for the STE to be eluted through the column reflects the saturated hydraulic conductivity (Ksat) of the RFM DMC and is determined by calculation (volume/time).

### Column Leaching Testing Environment Simulation

The 1 L of STE applied under constant-head conditions is approximately equivalent to a 420 mm rainfall event. After elution, any losses from the 1 L of STE are deemed to reflect the moisture holding capacity (MHC) of the RFM and is calculated using mass by difference.

The falling-head column test utilising a 1 L reservoir with a small tap fitted with a slow-release valve enables the STE to drip into the column rather than flow freely under constant-head conditions. The falling-head column test is to mimic low and/or intermittent rainfall conditions.

### Reactive Filter Media Design Module Data Analysis

A RFM's baseline metrics obtained from the preceding tests are modelled into one or more algorithms for a computerised program RFM design module to produce optimum RFM DMCs. These RFM DMCs are enabled to be used both immediately and/or hypothetically to predict performance under specific environmental conditions to decontaminate targeted contaminant fluids, such as waste water, taking into account influent treatment requirement variables.

Modelling Using the RFM Design Module

The selections of one or more RFM DMCs when placed in a specified RACS (discussed further below) are enabled to be modelled as shown in Table 5B (labelled as RFM+Pond). The impact of one or more RACSs alone (used as the “control” being in the absence of RFM, shown as Pond Only) are shown in Table 5B. That is, Table 5B “Pond Only” is the control.

This modelling enables parameters such as the reductions in Total Suspended Solids (TSS), Total Phosphorus (TP), Total Nitrogen (TN) and Gross Pollutants as shown in Table 5B for one or more specified RFM DMCs.

The existing “Pond Only” scenario relies on volume, depth and residence time to improve water quality as an “end-of-pipe” solution before discharge to the nearby creek as shown in FIG. 8A (reflecting and consistent with the modelling Table 5A). The issues with the pond regarding algal blooms and odour are part of a seasonal pattern that can only be improved by reducing the nutrients and sediment entering the pond, which are also taken into account by the modelling.

Specific modelling indicates that the optical placement of a plurality of specific RACSs, as shown in FIG. 8A, containing specific RFM DMCs as placed as treatment nodes within the catchment, as shown in FIG. 8B, does decrease the pollutant load entering the pond as shown in Table 5B for a specific RFM DMC as discussed previously.

Specifically, the modelling in Table 5B for a specific RFM DMC shows TSS and TP as reduced by 61.9% and TN by 49.1%. The improved runoff quality from using RFM is a function of reducing the pollutant loads before reaching the pond, leaving the pond with a lower pollutant load to treat.

The treatment-train created by using sub-catchment treatment nodes (RFM) is a fundamental concept of water sensitive urban design as opposed to traditional “end-of-pipe” solutions.

The RFM specific Design Mix Configurations (DMCs) as analysed in vivo and in situ, when implemented via one or more RACSs, or modelled using a computer RFM design module, demonstrated that the selectively implementing a range of recycled organic and mineral materials act as “new generation” Reactive Filter Media (RFM).

The data collected and analysed from in vivo and in situ, when implemented via one or more RACSs, is reflected in modelling using a computer RFM design module via the generated algorithms, to demonstrate performance characteristics of new generation RFM.

The performance of recycled organic and mineral material (in Design Mix Configurations) in removing nutrients and metals from STE is considerable in the column tests, which were a function of residence time and available exchange sites is confirmed via in situ RFM DCM contained in an RACS strategically place in a “treatment train”, which is further available for modelling in alternative environments.

Modelling RFM DCMs and RACS placement using the computer RFM design module also enables retro-fitting RACS specific RFM treatment nodes to reduced pollutant loads. Such modelling is also available for optimisation of replacement of existing pollution control systems such as drainage pits.

Referring to Table 5A and B, the percentage change in the constituent concentrations of:
1. bacteria, such as E Coli,
2. contaminants including nitrogen and phosphorous,
3. ions including potassium and sodium, and
4. metals in copper, zinc, cadmium and lead.

Table 5A and B show that the reductions as calculated as a percentage removal (expressed as a negative value) of the above constituent concentrations from stormwater. Positive values represent a release (or desorption) of specific constituents (such as Na, Ca and Mg) from the RFM of a specific design mix configuration (DMC). Sandy loam was used as a ‘control’ comparison as it is typical of what is currently being used as a filtration media in the stormwater industry.

Table 5A and B further shows that all RFM DMCs showed reductions in total nitrogen TN (26-47%) and in total phosphorous TP (8-85%). Specifically, the RFM's DMC1, DMC2 and DMC4 shows considerable removal rates for Ca2+ and Mg2+. The cation exchange dynamics between Ca2+, Mg2+, Na+ and K+ generally determine the available exchange sites for metals and, if they are dominantly occupied by Ca2+ and Mg2+, then there is less opportunity for metals under saturated conditions. There was limited removal across the DMCs of Zn+ and Pb+. Zn+ was removed by DMC1 and DMC2 (1-12%).

Decontamination Target Examples:

Metals

Metals in the form of zinc, aluminum, copper, magnesium, iron and/or boron may be removed by a RFM containing calcium carbonate, where the Ca2+ is exchanged for one of the metals to form, for example, copper carbonate or magnesium carbonate etc. Likewise, such contaminants can also be removed from the calcium chloride salt depending on the stability of the salt in a fluid medium. That is, where salts, carbonates and other compounds are used, they may be required to be held by an enteric coating and/or in a buffered environment to aid the stability of the compound. That is, to ensure that the compound is exchanging the targeted contaminant so as to lower the molarity of the targeted compound in the contaminated fluid.

### Bacterial Removal

Contaminated Fluid: Targeting Present and Future Harm

Contaminated fluid when collected over time provides a temporal analysis, which in turn may also provide a predictive analysis of succession in contamination.

For example, an increase in Escherichia coli or blue green algae in a contaminated fluid can indicate the breakdown of the fluid, such as a waterway's ecosystem, and increased harm to those exposed. Such predictive analysis can highlight the RFM's requirements to stop immediate harm and to limit a future harm occurring.

For further example, Escherichia coli contamination of stormwater can be indicative of contamination with sewerage containing faecal matter. This in turn, can lead to an outbreak of hepatitis; therefore, it is critical that the RFM contains an antibacterial agent to limit a disease outbreak.

An RFM containing an enteric coating for chelating and/or exchanging contaminants may include organic or inorganic substrates that react when a dissolved contaminant comes into contact with the coating.

For example, a RFM that contains fine sand with a disinfectant resin applied to act to reduce pathogenic bacteria from secondary treated effluent is one approach for decreasing bacterial load. The disinfectant resin comprising a resin and a curing solution applied to fine sand form an antibacterial agent.

This disinfectant coated fine sand reduced pathogenic bacteria from secondary treated effluent STE. Specifically, the treated STE when tested for E. Coli, a common microbial indicator of potential pathogenic bacteria, using the membrane filtration method and Millipore M-ColiBlue broth, showed that the bacterial load was negated. With the exposed filters were incubated at 38° C. for 24 hours then the “blue” colonies were counted to determine the concentration of E. Coli in cfu/100 mL, the bacteria load was nil.

The disinfectant resin is very effective in removing E. Coli after STE has come into contact with the coated fine sand, resulting in the total removal of pathogenic bacteria from the STE.

Pharmaceutical Removal

Water contaminated with pharmaceuticals is a serious environmental and human health threat due to their ubiquitous nature, ability to act on non-target biological systems and can cause chronic toxicity at low doses. Pharmaceuticals enter the environment through disposal or excretion, where they may still have a bioactive impact.

Specific RFMs are enabled to act on such pharmaceuticals using sorption and/or biodegradation. Such biodegradation is enabled by the RFM being activated with bacteria that can take up the pharmaceutical as a xenobiotic compound and, in turn, produce metabolites from the pharmaceutical within the bacteria's intracellular environment. These pharmaceutical metabolising bacteria may use a variety of techniques including mineralization, hydrophobic or hydrophilic transformation.

The activation of an RFM with specific bacteria is enabled via RFM culturing environments, which may include basic composting to raise the bacterial load to an acceptable and effective level. An activated RFM may also be achieved through using the RFM DMC, to be placed into a plurality of RACS, so as to form a treatment train.

Activated RFM DMCs may include bacteria such as Rhodococcus rhodochrous, the Pseudomonas species, such as Pseudomonas putida and/or Pseudomonas fluorescens, Sphingomonas herbicidovorans and/or Bacillus subtillis which are commonly found within soil or in the case of Bacillus subtillis, adverse conditions where the pH varies widely. These bacteria are affective in targeting specific pharmaceuticals, pesticides and/or steroids.

RFMs can also be inoculated with fungal spores, or cultured to grow fungi, which specific species are able to degrade particular pharmaceuticals and/or of the toxins. An example of such a fungi is Aspergillus niger.

Table 6 reveals the compounds that xenobacteria and/or fungi, when cultured within one or more RFMs or RFM DMCs, are enabled to remove and/or reduce toxicity.

Reactive Filter Media Containment

In a further embodiment of the invention is preferably insertable into a device, termed a RACS, which is formed from the acronym Reactive filter media Attachment Compartment Sock (RACS) System, device and method.

Embodiments of the present disclosure preferentially provide one or more RACS filtration devices to render contaminated water suitable to be received by the recipient environment.

### Sock

RACSs contain an outer Sock, for example made of geotextile material, which is porous and enabled to house one or more RFMs inserted into an internal compartment of each Sock. The Sock that provides a selected physical filtration medium, which physically strains and/or traps gross pollutants in the contaminated passing fluid. The Sock is designed to have an inner compartment so as to allow the removal by an RFM, that when used treats dissolved contaminants such as nutrients (e.g. nitrogen, phosphorous), metals (e.g. copper, iron, lead, zinc), bacteria (e.g. faecal coliforms) and hydrocarbons (e.g. petroleum) as well as finer sediments from the contaminated passing fluid.

The Sock, which includes the following forms of containment: a sock, sack, filterbale, filtersack and/or Reactive Filter Unit (RFU) (discussed below).

The exemplary embodiments described are frequently directed to Socks; however, it will also be apparent to the person skilled within the art that the use of the term Sock, as used in this description and in the summary can be generally applied to include one or more other forms of containment means including sacks, filterbales, filtersack and/or reactive filter units unless otherwise specifically referred.

This Sock containment provide a sediment filter boundary with an inner compartment to receive the RFM in the form of interchangeable contents, which in turn, selectively physically, chemically and/or biologically treats contaminant(s) contained within the passing contaminated fluid.

In this further embodiment, the RACS system and device comprises:
(a) RFM packed within each Sock, interchangeably received by:
(b) an inner Compartment housed within each Sock, the Compartment being capable of receiving RFM of specific DMC, contained within:
(c) a Sock, wherein the sock is available in a plurality of configurations including the form of a sock, sack, filtersack, filterbale, and/or reactive filter unit, which preferentially has:
(d) one or more Attachment means in the form of one or more handle(s) that are interlockable with the Attachment handle(s) onto another Sock, where this attachment is interlocking and reversibly engageable with a plurality of Socks varieties, so that the Socks are enable to be positioned in, for example, a stackable configuration, or in the case of a RFU the sacks are overlapped to ensure exposure to almost all of the RFM held within the sacks.

RACSs are configured in the form of socks, sacks, filtersacks, filterbales, and/or reactive filter units (generally hereafter referred to as Socks unless otherwise specified) are:
1) attachable in the form of being:
   a. anchourable to a suitable surface; or
   b. attachable to each other, and
2) stackable

so that RACSs are enabled to be attached to each other in parallel and/or in series to meet a contaminated fluid's:
1) filtration requirements, and/or
2) flow so as to route or limit the flow into a suitable direction;

so as to assist filtration of contaminated fluid flow (including other contamination remediation) at nominated positions. This enables a RACS to perform filtration by capturing sediment and contaminants using one or more RACS configurations (socks, filterbales, sacks and/or reactive filter units) separately or in combination.

Internal Compartment

Reactive filter media preferably contained within one or more internal compartments of a Sock (including a sock, sack, filterbale and/or filtersack) with an attachment means form a RACS. RACSs in the form of a sock and/or sack are flexible to take the form of the supporting surface upon which they are placed, so a portion of the RACS's surface is adjacent with the supporting surface.

The degree of the RACS's flexibility and the amount of surface area that a RACS surface meets with the supporting surface is dependent on the extent that the outer sock's (including the filterbale and/or the filtersack) inner compartment is packed with the reactive filtration medium. This flexibility is present with and without the presence of anchoring poles. A RACS is therefore enabled to be easily moved into position, making them especially useful on steep or rocky slopes where installation of other erosion control tools is not feasible.

The stackable socks, filterbales and/or filtersacks collectively form a skeleton. In referring to the sock alone, this is achieved by each sock being elongate where the cross sectional axis is enabled to take any form including that of an circle, ellipse, triangle, square and other form whilst still remaining malleable to be tightly engagable into a “stackable” (reversibly engageable) form with one or more other socks.

Socks filterbales and/or filtersacks may be stacked:
a. vertically (forming a wall),
b. horizontally, or side to side (forming a planar surface),
c. end to end (forming a pipe-like formation), and/or
d. using combinations of different sock formations including, for example, dual socks stacked with single socks, used for specific physical, chemical and/or biological treatment requirements.

A RACS provides three-dimensional filtering that retains sediment and other pollutants (e.g. suspended solids, nutrients, and hydrocarbons) while allowing the treated fluid to flow through. RACSs are enabled to be used in place of traditional sediment and erosion control tools such as a silt fence or straw bale barrier.

### RACS Selective Macro and Micro-Filtration

Selection of one or more RFMs insertion into one or more specific Socks to create an RACS optimised for a specific environment is enabled by the computer RFM design system (discussed above) for selecting the characteristics and behaviours which are most suitable for a specified environment:
1) the Sock, for macrofiltration; and/or
2) one or more RFM DMC's for macro- and micro-filtration/decontamination of one or more specific contaminants being sought to be filtered.

The selected RFM, as codified, is entered into computer design module's analysis algorithm to determine whether the RFM's performance in a specified RACS is able to decontaminate one or more pollutants in a proposed contaminated fluid flowing in specified environmental conditions.

In a further embodiment, as shown in FIG. 6, analysis is used to determine the RFM that is suitable to decontaminate the contaminated fluid using, for example, one or more samples of the following:
1) the contaminated fluid, and/or
2) the RFM as removed from the RACS.

Attachment

The reversible engagement between Sock including socks, sacks, filterbales, filtersacks and/or Reactive Filter Units may be of any suitable form, including a stickable outer surface, and/or one or more Attachment means in the form of handles (connectable in alignment), so that the water-sediment exchange devices are enabled to be stacked to meet contaminated water requirements. The attachment mean are also enabled to take the form of handles, which are enabled to be positioned on the outer surface of each sock, filterbales and/or filtersacks according to need.

The combination of stackable anchourable socks, filterbales and/or filtersacks enable sediment filtration “fences”, “floors” or “pipes” to be formed so that contaminated water flow is directed in a desired direction and protected from contaminating undesired areas.

The advantages of a RACS compared to other known sediment control tools, such as a silt fence, include:
1) RACSs are easily transported, installed and/or removed;
2) A RACS is enabled to be reused indefinitely only replacing the reactive filter media;
3) The disposal, post RACS filtration, involves only the removal of the reactive filtration media, which is a relatively small volume of material compared to known products; which results in
4) cost savings, either through reduced labor or disposal costs.

Referring to FIG. 1, a preferred embodiment of a RACS 100 is shown comprising:
1) an elongate sock 110 where the cross sectional axis is enabled to take any form including that of an circle, ellipse, triangle, square and other form whilst still remaining malleable to be tightly engagable into a “stackable” (reversibly engageable) form with one or more other socks, so as to provide the boundary of the sediment macrofilter with:
   a) the exterior surface of the sock 110 at least partially facing a source or body of contaminated water (not shown); and
   b) the interior of the sock forming an inner compartment (not shown) that allows a microfiltration medium to be held within the sock. The sock is thereby enabled to receive contaminated water flowing through the medium. The medium, held within the interior compartment, is interchangeable so that the content is enabled to selected and inserted into the compartment so as to capture, chelate or exchange (dependent on the contaminant type) specific contaminants as the contaminated water flows through this medium. This filter medium is discussed further below;
2) an attachment handle 120 so one or more socks are:
   a) attachable to each other;
   b) anchourable to a suitable surface (via an anchoring post or the like) when desired to be fixedly positioned; and
   c) capable of being handled easily (including by humans) so they are able to be carried to, or placed in, location when filled with a filter medium.
   The attachment means are fixed to the exterior of each sock, so that one or more socks can be carried to suitable locations and/or held in fixed positions (individually and collectively) by an anchoring device. These attachment means are also referred to as side handles in one arrangement of the preferred embodiment.

The turgor of the sock in FIG. 1 is enabled by holding, within its inner compartment, a reactive filter medium (contained but not shown in FIG. 1) as discussed further below.

In further embodiments the RACS may take alternate configurations, instead of an elongate tube (sock), in the form of a:
1) filtersack which takes the form of a sack with one or more inner compartments;
2) filterbales, which have a rigid frame; and/or
3) reactive filter units

These alternate configurations are discussed further below.

The RACS enables sediment filtration to take place through macrofiltration and microfiltration by the Sock type and RFM(s) selected to meet the environmental circumstances.

The macrofiltration is determined by the pore size of the sock 110 as shown in FIGS. 1 and 2. The Sock is formed out of a geotextile material which takes the form of a permeable fabric, which when in contact with the polluted fluid and/or soil, separates so as to selectively filter out gross materials depending on pore size with optional geonets to provide a parallel set of ribs to guide the drainage through the Sock. Alternatively, geogrids may be used with selectable geonets. Considerations as to which material to use for the sock may be selectable for environmental conditions entailed.

Referring to FIG. 3, exemplary sampling data shows the percentage of passing particulate matter (left ordinate) and the percentage of particles retained (right ordinate) against sieve size (abscissa). Therefore, the sieve size of the RACS Sock is enabled to be selected and changed for specific particle capture and, in conjunction to the qualities of the RFM which acts as an internal macro and micro filtration medium, the flow rate through the RACS is determinable.

The selection of the Sock and/or the RFM has advantages over known sediment control tools, such as a silt fence, including:
1) RFM retains a large volume of fluid, which helps prevent or reduce rill erosion (a shallow channel cut into soil by the erosive action of flowing fluid) and aids in establishing vegetation;
2) Sock and RFM's mix of particle sizes retains as much or more sediment than traditional perimeter controls, such as silt fences or hay bale barriers, while allowing a larger volume of clear fluid to pass through as shown in FIG. 4B (discussed further below). Silt fences often collapse and let all sediment through and/or become clogged with sediment and form a dam that retains stormwater, preventing the stormwater passing through;
3) RFM retain pollutants such as heavy metals, common metals in high concentrations such as iron, nitrogen, phosphorus, oil and grease, fuels, herbicides, pesticides, and other potentially hazardous substances, therefore improving the downstream fluid quality, and
4) Nutrients and hydrocarbons adsorbed by the RFM can be naturally cycled and decomposed through bioremediation by microorganisms commonly found in the compost matrix.

Macrofiltration can also include the filtration of particulates (including micro-particulates) and other contaminants using mediums such as sand contained within an RFM when it contains an oxidative surface, such as zeolite and/or magnesium/iron silicates.

RACSs are applicable to be used in environments including construction sites, industrial sites or other disturbed areas where potentially contaminated fluid, for example stormwater runoff, occurs as sheet flow.

Indicatively, a Sock is sued where the drainage area does not exceed 0.25 acre per 100 feet of device length and flow does not exceed one cubic foot per second. Socks are enabled to be used on steeper slopes with faster flows if they are spaced more closely, stacked beside and/or on top of each other, made in larger diameters, or used in combination with other stormwater RACSs configurations such as filterbales. Filterbales have flow rate of up 1 gallon per second per filterbale.

Stackable Socks (including filterbales and/or filtersacks) collectively form a skeleton when engaged with other Socks. The “stackability” is achieved through each Sock being reversibly engageable with one or more other Socks. The Socks may be stacked:
a. vertically (forming a wall),
b. horizontally, or side to side (forming a planar surface),
c. end to end (forming a pipe-like formation), and/or
d. using combinations of different sock formations including, for example, dual socks stacked with single socks, used for specific physical, chemical and/or biological treatment requirements.

The reversible engagement between Socks may be of any suitable form, including a stickable outer surface and/or one or more attachment handles (connectable in alignment), so that the RACS's water-sediment/contaminant exchange are optimised by positioning (such as being stacked) to meet contaminated water flow and exchange requirements.

RACS attachment handles can be positioned on the outer surface of each Sock according to need (i.e. the position can be varied according to need). The combination of stackable anchourable Socks enable sediment filtration “fences”, “floors” or “pipes” to be formed so that contaminated water flow is directed in a desired direction and prevented from contaminating undesired areas.

The reversible engagement means provides the RACS with flexibility for placement into a variety of environments including within or around confined spaces including drains and/or water courses. This is due to enabling any required number of Socks to be connected in a plurality of directions to form a suitably shaped structure (skeleton) with the desired flexibility or rigidity.

Indeed, the RACS skeleton may be flexible at some points and rigid at others, depending on need. This is achieved through the ability to pack content (reactive filtration media) within the compartment of each Sock as loosely or tightly as is desirable. How tightly packed a sock is can be varied at different points within the skeleton. This allows the RACS to sit along irregular surfaces and to bend when and where necessary. The tightness of packing can also be varied in time, as needs change. This is because each RACS compartment is reversibly sealed, allowing filter media to be added or removed for increased or decreased rigidity, respectively. If water flow changes, the structure or formation of the RACS is enabled to be varied accordingly.

Referring again to FIG. 1, the RACS comprises socks reversibly held in flexible formation so they are positionable and stackable as required to meet the environmental conditions and their potentially changing dynamics. In other words, the flexible formation of the RACS enables one or more socks to be:
a) placed onto a supporting surface 130—including an uneven surface or an inclined surface;
b) attached to the surface using an anchoring device;
c) attached to each other in parallel and/or in series, e.g. using reversibly engageable attachment material on the outer surface of the sock, or by other reversible engagement means such as anchoring posts threaded through attachment handles; and
d) reactive filter media (RFM) receivable by a sock into an inner compartment, so sock has turgor to provide a physical barrier to filter gross pollutants followed by filtration of contaminants by the internally housed RFM, so as to perform macro- and/or micro-filtration functions using a single or stepped decontamination process and/or to route water flow in a suitable direction.

An alternative embodiment 100 is shown in FIG. 2, in which the Sock is prism-shaped forming a filterbale, again forming a stackable RACS. Access 140 to the internal compartment is reversibly sealable. This is also applicable to the sock shown in FIG. 1; however, the internal compartment being reversibly sealable is not shown. Attachment means 120 and the placement of the filterbale Sock 110 onto a supporting surface 130 are also shown.

There are arrangements of the preferred embodiment with dual- and multi-compartmentalized-Socks where the internal compartment within a Sock is divided into series of compartments so that the media inserted into a first compartment can be followed by a second media into a second compartment and so on. This enables a series of filtration media to be encountered in a selected sequence as desired for the environmental circumstances.

The insertion of the media into a selected internal compartment within the Sock may have its own opening or use a common opening in other arrangements of the preferred embodiment.

### Internal Compartment Containing Reactive Filtration Media

The internal surface of the Sock provides an internal compartment to house reactive filtration media (RFM). This RFM is receivable into the RACS's internal compartment, so as to enable the RFM to be packed as loosely or as tightly as required and is reversibly enclosed and sealed within the RACS.

One advantage of the RFM being selectively packed into the RACS is that it maintains the flexible and malleable nature of the RACS. The exceptions to this RACS flexibility are the configurations of the filterbale and the Reactive Filter Unit (RFU).

Selection of one or more RFMs insertion into one or more specific Socks to create an RACS optimised for a specific environment is enabled to be assisted by a computer RFM design system (discussed previously) for selecting the characteristics and behaviours of a RFM DMC's decontamination for one or more specific contaminants being sought to be filtered.

If, for example, a specified contaminated fluid at a specified flow requires specific targets to be achieved for a specific RACS, then a RFM or RFM DCM, as design from the individual RFMs, is enabled to be selected to meet such requirements.

RFMs are enable to be substituted within an RACS by removing a used RFM from a RACS compartment and replaced with one or more new RFMs. The combination of RFMs may be chosen to be placed within or across several adjacent compartments within one or more Socks so as to create an array for sequential decontamination of a contaminated fluid.

This flexible and malleable nature maintains the ability of the RACS to be placed onto a surface so that it is fully engaged along all points of the supporting surface's topology. The degree of the RACS surface area meeting with the supporting surface will depend on the firmness that the RFM was selectively packed into the RACS.

### RACS Positioning

RACSs are usually placed along a contour perpendicular or tangential to sheet flow, in areas of concentrated flow they are sometimes placed in an inverted V or C curve going up the slope, to reduce the velocity of fluid running down the slope.

Higher flow products such as filterbales and reactive filer units (RFU) are enabled to be used in regions subject to very high rainfall and runoff conditions. Socks and sacks are enabled to be used in conjunction with filterbales and RFU at the top and base of the slope by placing a series of socks, sack and/or filterbales/RFU at selected distances, such as every 15 to 25 feet along the vertical profile of the slope.

These RACSs act as slope interruption devices slow down sheet flow on a slope or in a fluid shed. Larger diameter socks and/or filterbales are selected for areas prone to high rainfall or sites with severe grades or long slopes. Filterbales incorporate a joining system which enables them to be secured side by side in a line enabling long structures to be used.

By placing RACSs in parallel with the same or different porous material pore size and filtration mediums, there may be further cleansing of the same contaminant, cleansing of different contaminant and/or the addition of a new substance such as growth medium. Therefore, the RACS enables a series of selected filtration steps to be pursued.

Considerations of the RACS design selections include those listed in Table 1 included within the FIGS. 1 and 2. Performance modelling of specific RACS sock porous material in combination with selected mediums has specific sediment filtration successes as shown in Table 2 as discussed previously.

The Sock-contaminant exchange paths are enabled to be:
1. sampled at the sediment capture interfaces of RACS Sock and/or RFM, and
2. mapped using the computer aided RFM design and analysis (discussed previously),

so that prior to, say, entering storm fluid drains, the degree of decontamination is enabled to be adjusted as required according to the contaminant-water required by environmental standards.

### Plurality of RACSs Positioned in Parallel

RACSs are enabled to be positioned in parallel so that they are attached on the elongate side so that they can provide an increased surface area in the form of a fence to meet increased fluid volume or height.

Likewise, a plurality of RACSs is enabled to be positioned in parallel to meet filtration requirements. That is, the RACSs may deal with the highest concentration of contaminant when the contaminated fluid flows through the first RACS, whilst the second RACS in the parallel sequence will receive the partially decontaminated fluid from the first RACS.

This sequence of decontamination steps can be continued as required by environmental needs. That is, each RACS in turn contributes to a stepped decontamination sequence to obtain an acceptable level of decontamination. This sequential filtration is enabled to be used for either or both macro- and/or micro-filtration sequences (e.g. to resolve, for example, ionic exchange conflicts).

Alternatively, dual socks or socks with a plurality of internal compartments may also perform this decontamination sequence as required, depending on flow and exchange requirements.

Fluid flow and sediment capture involved activities have many inter-dependences, so that flow and filtration is enabled to be strategically optimised. For example, when using the sequential filtration steps using one or more RACSs, the filtration processes are optimised by removing sediment solids before targeting specific toxins or contaminants. The RACS is enabled to make such filtration optimisations possible by optimising which filtration step in the process has the greater efficiency or dependency on the other filtration steps involve.

For example, optimised filtration may involve the use of macro filtration before involving microfiltration so that the removal of contaminants as a second step is optimised due to controlling access of the RFM to the contaminated fluid (the contaminant is no longer bound in sediment, due to the sediment being removed at an earlier stage) whilst maintaining sufficient fluid flow. That is, one or more RACSs can be used to optimise the filtration by targeting decontamination and using fluid flow in an optimised sequence to help such decontamination. For example, see the ionic exchange profiles discussed previously and shown in Table 2.

Sequential filtration may also be selectable for the contamination type or series of contaminants. For example:
1. a first RACS may filter sediment and/or contaminant X, as selected and determined by the RACS sock's filtering porous material or the filtering contents contained within internal compartment, followed by
2. a second RACS, which may filter sediment and/or contaminant Y, as further selected and determined by the sock's filtering porous material or the filtering contents contained within internal compartment, and so on.

Sediment-fluid filtration adjustment is enabled so as to have correlation against acceptable standards. For example, sediment capture detail drawn from samples contained within the internal compartment contents is enabled such that the RACS sock is reversibly sealed to hold the internal contents; however such contents may be removed for testing and/or exchanged with another microfilter more suitable to the environmental requirements and existing filtration targets. Therefore, filtration mediums are enabled to be changed as the environmental needs change. This also enables re-evaluation of contamination levels as filtration mediums are changed. This provides an accurate determination of the pollution levels within a fluid supply since a RACS will filter contaminants over time, which provides a more accurate insight to pollution levels over taking small fluid samples at a fixed time. This is particularly important when there are pollutants that are not evenly distributed through the contaminated fluid.

This re-evaluation step may be optional but preferential if the RACS functions are to be optimised or to be targeted to a specific contaminant. Therefore, once a re-evaluation step has been selected, the sediment-fluid exchanged is enabled to be monitored before proceeding to the next step of the filter device decontamination process.

One advantage of positioning a RACS is that no trenching is generally required therefore soil is not disturbed upon installation. RACSs are therefore able to be installed on frozen ground or even cement.

### RACS Positioning to Optimise Filtration Along with Fluid Flow Dynamics

The RACS takes the form of one or more sediment filter socks reversibly engaged together to collectively form a RACS skeleton. The RACS is enabled to be placed directly onto a surface, such as a road, so that contaminated fluid will flow through the RACS and undergo filtration. The RACS skeleton is malleable so that it is enabled to be bent into a desired position to intercept contaminated fluid flow.

The flexible form of the RACS further enables it to be placed on uneven surfaces without allowing sub currents forming through small openings that arise when solid frames are placed onto uneven surfaces (e.g. fluid paths, stony brooks, undulating or eroded surfaces et cetera). This is often advantageous when specific filtration is required within drains and pipes or at entries to/within storm fluid drains.

Likewise, storm fluid drains are useful for normal rainfall, but not during flooding (e.g. annual or fifty year floods). During flooding, control of flow into storm fluid drains must be slowed or staged, since back-flooding from storm fluid drains will occur due to over capacity. These events are not unusual in regions prone to flooding. Therefore, a RACS can be positioned within trenches, on banks and/or in storm fluid drains to reduce fluid flow. FIG. 4A is an example of fluid flow reduction, achieved by using a RACS as an infiltration technique to slow storm fluid runoff over time. Referring to FIG. 4B, exemplary data are provided showing the reduction in fluid flow achieved through installation of a RACS and an enhanced collection of suspended solids (79.5%) that take place during a flood (right column). The left column shows storm fluid flow without use of a RACS. Keeping drains clear of solids is critical during flooding to maintain drainage. Installation of a RACS within storm fluid drains during flooding can assist to maintain drainage during flooding.

The modular nature of the RACS enables quick deployment into tight, irregular, remote and/or inaccessible regions. The RACS skeleton can be held in place (and held together) by friction between the outer surface of the sock(s) and a rough supporting surface (for example, the road or unpaved path) and/or through securing of attachment handles (using a post or the like).

Once deployed, a RACS is able to guide the flow of the contaminated fluid depending on the positioning and shape of the RACS skeleton. That is, if a RACS is placed along the flow of fluid, then the flow will not be redirected; however, if the RACS is placed at an acute angle to the flow of fluid, then the flow will be partially re-routed to follow the direction of the elongate side of the RACS, whilst a portion of the fluid will be flowing through the porous material of the RACS and any content enclosed by the RACS and therefore will be undergoing filtration.

If a plurality of socks is engaged to form a cup-like configuration, with the cup's interior collecting the contaminated fluid flow, then this cup-shaped RACS will achieve maximal filtration since the configuration maximises the contaminated fluid flow pressure through the RACS porous material. If the rate of filtration of the contaminated fluid is too slow compared to the inflow of contaminated fluid, then there will be damming of the contaminated fluid.

To overcome such damming problems, a series of RACS skeletons can be positioned, for example, in parallel, so that the fluid flow is optimised due to relief of the pressure of a single dam and maximal filtration by having multiple RACSs and therefore increased surface area. The increased surface area also assists to minimise the risk of oversaturation of the RFM within the socks or blockages of the macro-filtering outer surface of the socks.

A plurality of RACSs can also be placed in series so that they are connected at their narrowest portion to form an extended RACS to re-route contaminated fluid in a selectable direction.

The sock provides a path to direct the contaminated fluid into the RFM so as to optimise the exchange rate in association with the contaminated fluid flow rate.

### RACS Method of Filtration

The invention also provides a method of filtration using a RACS. The method follows one or more of the following steps to capture one or more specific sediments and/or contaminants.

Sediment is filtered out of fluid according to the following:
1. the pore size of the porous outer material used to construct each sock, which captures and/or redirect course sediment along and on the outside of the RACS; then
2. a proportion of the finer sediment is forced through the porous material via the fluid pressure meeting the external surface of the RACS, so as to force the contaminated, coarse-sediment-free fluid through the contained filtration medium.

Filtration of sediment size and/or contaminant's concentration will be dependent on the exchange dynamics of the RACS exterior porous material and/or the RFMs contained. Bespoke media engineering enables customisation for specific performance requirements. The pore size of the porous material on the exterior of the RACS and the RFM within the RACS enable hydraulic conductivity to be optimised to maximise filtration and/or manage flows to, for example, reduce flooding.

In one embodiment of the present invention, external events, such as the environmental conditions, can be met by targeted environmental decontamination objectives. These are referred to as internal events that can be selected for by the selection of fluid-sediment exchange through the RACS device selection of:
1. RACS filtration fabric (exterior porous material); in combination with
2. the RACS containment of the microfiltration medium content, which together provide a sediment capture and output decontamination interface.

An example of different porous material and medium selections is shown in FIGS. 5A and 5B, which show marked reductions in the contaminant outflow and overall fluid quality improvement.

### SACKS

Sacks may be used with the RFM rather than one or more socks. Socks and sacks re the same except for sizing:

Socks are longitudinal whilst being round, oval, D-shaped or taking another selectable form in cross section, whereas sacks are geotextile bags (look more like lounge cushions or pillow shaped).

The inner compartments are full of bespoke filtration media that is inserted into a filterbale, which is a device for above ground sediment filtration. A sack and a filterbale are forms of a RACS that have specially designed reversible seal locking system to insert and/or re-insert filtration so as to re-use the geotextile cover.

For example, in one arrangement of the preferred embodiment sacks and/or filterbales are reversibly sealed following the insertion of the RFM with a joining system, form by a Velcro fixture or other sealing material, to ensure that the runoff fluid does not force the RFM to break through the seal. In cases where this seal requires additional protection, the socks are placed end-to-end along a slope and the ends to be interlocked, so as to provide additional support to the seal.

### Filterbale

Filterbales have in common with filtersacks and sock:
1) an outer cover;
2) an entry point into an inner compartment from this outer cover that is reversibly sealable in common with the sock and filtersacks, and
3) an attachment means.

However, in a further embodiment filterbales have one or more of the following:
1) an inner compartment that receives RFM in the form of one or more replaceable RFM cartridges filled with a selectable and preferred RFM, where the outer surface of the cartridge is made of a porous material such as a geotextile material. The inner compartment is enabled to be filled with cartridges or to be partially empty so they are enabled to efficiently collect and retain silt and sediment run-off whilst removing contaminants such as chemical, nutrient and biological contaminants using the selected RFM cartridge situated at the base of the filterbale drainage cell. For example, gross pollutants such as leaves, litter and other solids are enabled to be trapped above the RFM cartridge, whilst the contaminated fluid passes through the RFM cartridge at the base of the drainage cell; and
2) the outer cover is held in a shape of a drainage cell by using a stage in the form of a rigid rectangular frame. In one arrangement this stage takes the form of an internal filterbale frame covered by the outer cover, so as to allow fluid to pass through in a motion that oxygenates, rejuvenates and re-invigorates the passing fluid.

This is developed for higher flow situations to substantially reduce the migration of sediment and contaminants into drainage systems while allowing decontaminated fluid to easily pass through.

In one arrangement of this embodiment, a sack for use within a filterbale is approximately 700 mm×420 mm×150 mm-200 mm thick. Other arrangements may have sacks of differing sizes.

A filterbale in a further arrangement has an exoskeleton made from cellular high density plastic or environmentally friendly alternative material that forms an external frame around the sack. This frame allows fluid to pass through it so that is oxygenated. Such devices are suitable for higher flow rates and higher retention time such as 1 in 10 year floods where retention of fluid is required for at least 48 hours and at capacities such as 4 inch storm events.

One or more sacks are also enabled to be inserted into filterbales during building construction phases or in strategic high pollutant loading sites. Filterbale sacks can have replaceable filtration medium cartridges or loose filtration mediums inserted. Alternatively, several sacks are insertable into a reactive filter unit (RFU).

### Reactive Filter Unit

A RFU is a bigger version of a filterbale. An RFU, for example, may typically be one metre cubed; however, this size is scalable from 10% to 10,000% as required. RFU are enabled to manage higher flows than RACSs in the form of socks, sacks or filterbales.

In one arrangement of this embodiment, RFU may contain RACSs in the form of sacks, where these sacks are approximately 1000 mm×300 mm×200 mm thick. Typically, a RFU is enabled to contain up to 12 sacks. Other arrangement may have different size sacks as well sacks of different sizes.

### Drain Inserts

Drain Inserts (type of filterbale i.e. filterbale drain inserts) contain a cartridge system, holding RFM (RFM) to specially target pollutants from roads, parking lots and other sealed surfaces, to:
1. capture pollution runoff from roads;
2. filter the runoff via the RFM; and
3. lead the treated fluid into the drainage system.

The Drain Insert is durable with the frame constructed from high density recycled plastic/metal and are shaped to be easily installed and maintained into selected drainage systems. Drain Insert are also used to direct fluid flow out of the RACS, Filterbale and/or an RFU into a drain. There are also skirts on four sides that direct the fluid into the Filterbale as it is generally smaller the drain pit.

A Drain Insert is suspended from the drain's existing grate by straps that attach to a securing connector such as a Velcro tabs via the attachment means on the RACS, Filterbale and/or an RFU into a drain.

The cartridges contained within a Drain Insert are replaceable and/or cleanable via a back flushing. The frame also enables oxygenation of the treated fluid prior to discharging into the drain.

### RACS Selection of Socks the Form of a Sock, Sack, Filtersack, Filterbale and/or a Reactive Filter Unit

A RACS is a filtration device provides that provides a macro-filtration and micro-filtration as to when a critical filtration requirement needs to be met. The RACS selection is dependent on the targeted:
1. contaminant removal: are they particulate and/or dissolved, hydrocarbons, metals, nutrients & bacteria (or a combination of these)
2. Lifespan of the contaminant: will it remain or decompose to an acceptable level with a suitable period?
3. Hydraulic conductivity of the RACS sock (pore size, ionization characteristics, etc.)
4. Flow management, so as to control filtration in an acceptable level: if flow is too slow, then adequate filtration is no achieved, whilst fast flow may not allow filtration to keep pace with flow;
5. Leachate management, where any medium must take into account the impact not only in filtering a contaminant, but also adding a new component into the fluid flowing through the RACS including its accompanying RFM;
6. Stability of the RACS is selected so that it is degradable if it is act as a nutrient source and/or remain in the area as landfill etc.;
7. Treatment train designs, where multiple passes of contaminated fluid passes through a plurality of RACSs, such that a first pass of contaminated fluid has filtered out a desired contaminant, then there may be subsequent contaminants that main need to be removed.

### Recycling

Once a contaminant and the associated potential chemical exchanger(s) are captured within the selected RFM, then removal and replacement of the medium from the RACS or sack is enabled if desired (RACS includes sacks in this section forward). This enables recycling of the RACS and/or the RACS filtration medium. The recycling of the RACS and/or removed medium are available as a nutrient source, if the contaminants collected are acceptable. For example, the filtration of grey fluid makes RACS and the accompanying medium very suitable for recycling since they are nutrient rich.

The RFM is enabled to contain selected nutrients and biologically beneficial metals higher than that contained in some topsoils. This, however, does not translate into higher metals and nutrient concentrations or loads in stormwater runoff. A study by Glanville, et al. (2003) compared the stormwater runoff fluid quality from compost and topsoil treated plots. They found that although the composts used in the study contained statistically higher metal and nutrient concentrations than the topsoils used, the total masses of nutrients and metals in the runoff from the compost treated plots were significantly less than plots treated with topsoil. Likewise, Faucette et al. (2005) found that nitrogen and phosphorus loads from hydroseed and silt fence treated plots were significantly greater than plots treated with compost blankets and filter berms. In areas where the receiving fluids contain high nutrient levels, the RFM product is enabled to be selected to meet the performance requirements of the site. The nutrients in an RFM organic material are in organic form and are therefore less soluble and less likely to migrate into receiving fluids.

The inner compartment of the RACS, when containing a medium that has filtered a contaminant (via chelation etc.), may selectively also be left within the RACS so as to not disturb the contaminant within the medium. The RACS may potentially continue to filter out other contaminants and/or be disposed of safely, as landfill or as a nutrient source if the medium and contaminants are suitable, depending on:
1. whether there are biohazards contained, or used;
2. the ability to identify and accurately estimate the pollutant retention lifespan of the RACS and its contents, and
3. whether the RFM was designed to be optimally disposed of as a nutrient source. This is one of the benefits of using a computer aided RMF design for specific filtration and disposal.

### Recycling of RACS Components

Each component of a RACS is replaceable and/or recyclable as a modular component.

Replacement of the RACS's exterior cover, such as the geotextile material along with the internal RFM and/or the filterbale's filter cartridge(s) (containing the RFM) is enabled and dependent on the loadings of silt and sediment. Likewise, the filterbale frame is made from a recyclable and replaceable material.

The cleansing of RACS components is enabled, where:

1. silt/sediment accumulated up against the exterior surface of the RACS is enabled to be removed and (when dry) the front face of the filterbales brushed to retain porosity for the next flows;

2. If the outer material, such as the geotextile surrounding the RACS, blocks it is enabled to be cleaned by, for example, brushing with a stiff broom.

### Attachment of RACSs

RACSs are enabled to be attached to each other along either the elongate side or end to end. The attachment means is through a reversibly engageable material such as Velcro and other reversibly engageable materials. Velcro strips on each corner of the filterbale enables the formation of a wall. For example, positioning the filterbale side by side as attached together via the Velcro strips on each corner enables each sock to be added as a unit to build a wall or barrier in the length as required.

The preferred anchoring method is to put stakes through the built in loops of the RACS at regular intervals; alternatively, stakes can be placed on the downstream side of the product. The ends of the RACS containing the reversible seal into the internal compartment should be directed upslope, to prevent stormwater from running around the end of the product or to force a break in the seal. A RACS may also be retained (e.g. up against a perimeter fence) if it is not required to be anchored to the site or slope via the attachment means.

### Stackable RACSs

RACSs are stackable upon each other through the use of the attachment means described above. The advantage of being stackable as well as, in the case of socks and sacks, being flexible is that anchouring poles are enabled to be inserted through each RACS's handle to build filtration fences/guides/filtering walls with additional structure and/or anchouring strength when compared to the attachments (e.g. Velcro) alone.

These attachment and/or anchouring features enable desired and/or environmentally required (flooding containment etc.) formations to be constructed from a plurality of RACSs so as to select the RACSs:
1. surface area available for filtration;
2. position to control contaminated fluid's flow speed and direction both across and along the RACSs.

The flexibility of the RACS enables one or more RACS types (sock, sack, filterbale and/or RFU) to be placed in preferred and in the case of socks, even in confined positions. To date many solutions with fixed frames have not been altered positioned into unusual, awkward and/or confined positions.

RACSs are Manageable Via Human Labour

RACSs have handles located on the external surface of the RACS sock to enable one or more RACSs to be held and/or placed in position. RACSs are enabled to be held in position by using anchoring devices such as one or more fence posts such as a star picket. This enables a plurality of RACSs to be placed in fixed positions in the form of fence so they are able to undertake considerable pressure from contaminated fluid flow, without being washed away.

Referring to FIG. 1, in the preferred embodiment of one or more RACSs 100 in the form of a filtration program does not need to incorporate compartmentalisation with a filter but enables specific sediment/toxin/contaminant exchange interfaces enabling the steps of:
1. sediment filtration from:
   a. sediment capture using one or more of the following
      i. external interface of the sock 110 via sediment capture input; and/or
      ii. internal medium selection (not shown) so that sediment capture is enabled by the fluid flow through the medium;
   so that sediment capture is enabled.

A sediment capture is enabled by one or more RACSs, which receive sediment via:
2. binding the sediment from the fluid with one or more RFM chemical exchangers as selected for the fluid flow as routed through the SCAH, so as to fulfill the sediment capture requirements. This enables fluid flow's resources to be more fully utilised, since the fluid flow is now providing the energy to perform the sediment filtration. Therefore, no mechanical means of cleaning is required.

There are preferential steps that are additional optional steps including one or more steps following Steps 1 and 2 above including:
3. stackable RACS via the RACS's reversibly engagable or stickable outer surface (alternatively the handle connectors are enabled to be used to bind the RACS together), so that the RACS is enabled to be selected in a sequential manner. For example, one arrangement of this embodiment allows for the maximal sediment filtration taking place with the first RACS in line, followed by further sediment filtration taking place with the next RACS in line, and so on until suitable sediment filtration has taken place;
4. flexible RACS placement to ensure the sediment capture is optimised by guiding contaminated fluid flow routes to efficiently utilise fluid flow rate and flow pressure to ensure maximal filtration at least resource cost; and
5. enable one or more RACS to be selected for the conditions available as shown in FIG. 6, where the RACS is selected for fluid flow, depth and filtration properties. These selected RACS are then to be placed on the selected fluid flow routes for sediment capture, so that the optimisation, for example, to minimise the steps required by removing any duplication of RACS. That is, a RACS is selected for the conditions and sediment filtration needs.

The application of one or more RACSs into an environment enables a user to select the least number of RACSs for sediment capture according to a RACS's external fabric and internal medium. That is, RACSs are enabled to be adapted according to sediment filtration requirements, and if required, to stage filtration so that the RACS follows a stepwise sediment filtration sequence to provide decontamination/remediation according to sediment capture's selection requirements.

For example, where a fluid-sediment exchange solution is required for a specific sediment capture (or for a specific environment, where other considerations narrow the options available), then the sediment(s) are enabled to be captured by the application of one or more RACSs. FIG. 7 shows some of these environments and the considerations taken into account.

### RFM Alone or with an RACS: Areas of Use

An RFM alone, or a RACS (discussed below as an alternate embodiment) containing one or more selected RFMs, to be used in vegetated areas suitable for human habitation including:
1. Rain gardens
2. Landscape areas
3. Roof gardens
4. Retaining walls
5. Sports fields
6. Planter boxes

Use in vegetated areas includes physical, chemical and/or biological treatment of pollution runoff in areas including:
1. Leach drains
2. Swales
3. Wetlands

Use in non-vegetated applications such as:

1. Sand filters

2. Detention basins

3. Pavement sub base (non-structural grade)

4. Pavement sub base (structural grade)

5. Kerb-gully by-pass system

6. Under permeable paving system

7. Sub-surface drainage systems

8. Car park

One advantage of a RACS is that it enables one or more sediment captures to be reviewed where the details of the contaminant capture needs confirmation.

Growth promoters and/or bacterial substrates may be used as the medium contained with the RACS to enhance the fluid flow recipient crop's growth and/or reduce weed growth. Further, nutrients and/or probiotics/biota are able to be added to the RACS's medium.

By providing RACSs to, for example, storm fluid drains inlet or internal pipe, the RACS is enabled to filter device according to contamination and environmental needs.

The invention thus provides one or more RACSs, method and system that overcomes at least one of the problems of prior art by assisting fluid flow at its filtration points or boundaries to filter and/or exchange contaminants in a more stepwise manner and to provide a means to enable exchange requirements between fluid flow, a sediment capture at one or more nominated positions according to need.

The invention provides a RACS for specific sediment filtering to meet immediate environmental needs. However, it will be appreciated that the invention is not restricted to this particular field or limited to particular embodiments or applications described herein.

Comprises/comprising when used in this specification is taken to specify the presence of stated features, integers, steps or performance but does not preclude the presence or addition of one or more other features, integers, steps, performance or groups thereof. Thus, unless the context clearly requires otherwise, throughout the description and the claims, the fluid flow's activities ‘comprise’, ‘comprising’, and the like are to be construed in an inclusive sense as opposed to an exclusive or exhaustive sense; that is to say, in the sense of “including, but not limited to.

What is claimed is:

1. A filtration system, comprising:
a malleable compartment;
a permeable fabric forming an exterior of the malleable compartment, the exterior of the malleable compartment to at least partially face a contaminated fluid;
a first pore size defining a permeability of the permeable fabric;
an interchangeable microfiltration medium held within an interior of the malleable compartment, the microfiltration medium having a second pore size, the second pore size being smaller than the first pore size; and
a handle affixed to the exterior of the malleable compartment.

2. The filtration system of claim 1, the malleable compartment being a filtersack.

3. The filtration system of claim 1, the malleable compartment being a filterbale having a rigid frame.

4. The filtration system of claim 1, the malleable compartment being a sock.

5. The filtration system of claim 4, the sock having a cross-section, the cross-section being one selected from the group consisting of:
a circle;
an ellipse;
a triangle; and
a square.

6. The filtration system of claim 1, the malleable compartment being a first malleable compartment, the filtration system further comprising:
a second malleable compartment substantially identical to the first malleable compartment, the second malleable compartment being stacked with the first malleable compartment.

7. The filtration system of claim 1, the handle of the first malleable compartment being connected to the second malleable compartment.

8. The filtration system of claim 1, the malleable compartment being a first malleable compartment, the filtration system further comprising:
a second malleable compartment stacked with the first malleable compartment, the second malleable compartment comprising a different interchangeable microfiltration medium than the interchangeable microfiltration medium of the first malleable compartment.

9. The filtration system of claim 1, the handle of the first malleable compartment being connected to the second malleable compartment.

10. The filtration system of claim 1, the interchangeable microfiltration medium being a chemical microfiltration unit.

11. The filtration system of claim 1, the interchangeable microfiltration medium being a toxin microfiltration unit.

12. The filtration system of claim 1, the handle being an anchor to fixedly position the malleable compartment to an external surface.

13. The filtration system of claim 1, the handle being a carrying handle.
